(19) United States
(12) Patent Application Publication
(10) Pub. No.: US 2021/0107579 A1
(43) Pub. Date: Apr. 15, 2021

(54) VEHICLE STATION SYSTEM

(71) Applicant: Trek Bicycle Corporation, Waterloo, WI (US)

(72) Inventors: Stephen Adam, Madison, WI (US); Ben Gavin, Madison, WI (US); Mike Van Dyke, Madison, WI (US)

(21) Appl. No.: 17/004,624

(22) Filed: Aug. 27, 2020

Related U.S. Application Data
(60) Provisional application No. 62/914,907, filed on Oct. 14, 2019.

(51) Int. Cl. B62H 3/00; B60L 53/51

(52) U.S. Cl. CPC B62H 3/00; B62H 2003/005; B60L 53/51

(57) ABSTRACT

A vehicle station system includes a dock having a latch configured to secure a bicycle to the dock and release the bicycle from the dock. The dock also includes a computing system that includes a processor and an interface operatively coupled to the processor and configured to receive authentication information from a user. The processor is configured to authenticate the user based on the authentication information, and, responsive to authentication of the user, cause the latch to transition from a locked configuration to an open configuration such that the user can remove the bicycle from the dock. The computing system also includes a transceiver operatively coupled to the processor and configured to maintain a communication connection between the dock and a remote server. The transceiver is also configured to transmit a user identification corresponding to the user and a bicycle identification corresponding to the bicycle to the remote server.

### CROSS-REFERENCE TO RELATED APPLICATION

The present application claims the priority benefit of U.S. Provisional Patent App. No. 62/914,907 filed on Oct. 14, 2019, the entire disclosure of which is incorporated by reference herein.

### BACKGROUND

A vehicle station system refers to a system that makes vehicles available to users on a short term basis, typically for a rental fee. As an example, a bicycle station system allows users to check out a shared bicycle from a bicycle dock for a period of time during which the user is able to ride the bicycle. When the user is done with the bicycle, he/she returns the bicycle to another bicycle dock (which may or may not be the dock from which the bicycle was received). The bicycle dock typically includes a security system that is intended to prevent unauthorized users from accessing the shared bicycle.

### SUMMARY

An illustrative vehicle station system includes a base assembly and a dock mounted to the base assembly. The dock includes a latch configured to secure a bicycle to the dock and release the bicycle from the dock. The dock also includes a computing system that includes a processor and an interface operatively coupled to the processor and configured to receive authentication information from a user. The processor is configured to authenticate the user based on the authentication information, and, responsive to authentication of the user, cause the latch to transition from a locked configuration to an open configuration such that the user can remove the bicycle from the dock. The computing system of the dock also includes a transceiver operatively coupled to the processor and configured to maintain a persistent communication connection between the dock and a remote server via a resumption protocol. The transceiver is also configured to transmit a user identification corresponding to the user and a bicycle identification corresponding to the bicycle to the remote server.

Another illustrative vehicle station system includes a base assembly, and a dock and a kiosk mounted to the base assembly. The dock includes a latch configured to secure a bicycle to the dock and release the bicycle from the dock. The kiosk includes a computing system having a processor and an interface operatively coupled to the processor and configured to receive authentication information from a user. The processor is configured to authenticate the user based on the authentication information, and, responsive to authentication of the user, cause the latch to transition from a locked configuration to an open configuration such that the user can remove the bicycle from the dock. The computing system also includes a transceiver operatively coupled to the processor and configured to transmit a user identification corresponding to the user and a bicycle identification corresponding to the bicycle to a remote server.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a side view of a bicycle in accordance with an illustrative embodiment.

FIG. 2 is a perspective view of the bicycle of FIG. 1 in accordance with an illustrative embodiment.

FIG. 3 is a side view of a rack in accordance with an illustrative embodiment.

FIG. 4 is a front view of the rack of FIG. 3 in accordance with an illustrative embodiment.

FIG. 5 is a perspective view of the rack of FIG. 3 in accordance with an illustrative embodiment.

FIG. 6 is a side view of the rack depicting its adjustability to receive and hold items (e.g., a bag of groceries) in accordance with an illustrative embodiment.

FIG. 7 is a rear perspective view of the rack and a handlebar of the bicycle in accordance with an illustrative embodiment.

FIG. 8 is a front view of a vehicle station in accordance with an illustrative embodiment.

FIG. 9 is a right side view of the vehicle station in accordance with an illustrative embodiment.

FIG. 10 is a rear view of the vehicle station in accordance with an illustrative embodiment.

FIG. 11 is a left side view of the vehicle station in accordance with an illustrative embodiment.

FIG. 12 is a top view of the vehicle station in accordance with an illustrative embodiment.

FIG. 13 is a bottom view of the vehicle station in accordance with an illustrative embodiment.

FIG. 14 is a perspective view of the vehicle station in accordance with an illustrative embodiment.

FIG. 15 is a perspective view of a bicycle station in accordance with another illustrative embodiment.

FIG. 16 is a side view of a light-emitting diode (LED) advertising display of a bicycle station in accordance with an illustrative embodiment.

FIG. 17 is a side view of a map display of a bicycle station in accordance with an illustrative embodiment.

FIG. 18 is a front view of a kiosk of the vehicle station in accordance with an illustrative embodiment.

FIG. 19 is a rear view of the kiosk in accordance with an illustrative embodiment.

FIG. 20 is a side view (the left and right sides can be mirror images) of the kiosk in accordance with an illustrative embodiment.

FIG. 21 is a bottom view of the kiosk in accordance with an illustrative embodiment.

FIG. 22 is a top view of the kiosk in accordance with an illustrative embodiment.

FIG. 23 is a perspective view of the kiosk in accordance with an illustrative embodiment.

FIG. 24 is a front view of a kiosk in accordance with another illustrative embodiment.

FIG. 25 is a side view depicting solar panel movement of a bicycle station in accordance with an illustrative embodiment.

FIG. 26A is a block diagram of a card reader for a bicycle station in accordance with an illustrative embodiment.

FIG. 26B depicts a user authorization element in the form of a card reader in accordance with an illustrative embodiment.

FIG. 27 is a front view of a dock of the vehicle station in accordance with an illustrative embodiment.

FIG. 28 is a rear view of the dock of the vehicle station in accordance with an illustrative embodiment.

FIG. 29 is a top view of the dock of the vehicle station in accordance with an illustrative embodiment.

FIG. 30 is a bottom view of the dock of the vehicle station in accordance with an illustrative embodiment.

FIG. 31 is a left side view of the dock of the vehicle station in accordance with an illustrative embodiment.

FIG. 32 is a right side view of the dock of the vehicle station in accordance with an illustrative embodiment.

FIG. 33 is a perspective view of the dock of the vehicle station in accordance with an illustrative embodiment.

FIG. 34 is a perspective view of a docking station in accordance with another illustrative embodiment.

FIG. 35 is a top view of a base assembly of the vehicle station in accordance with an illustrative embodiment.

FIG. 36 is a bottom view of the base assembly in accordance with an illustrative embodiment.

FIG. 37 is a front view of the base assembly in accordance with an illustrative embodiment.

FIG. 38 is a side view (the left and right sides can be mirror images) of the base assembly in accordance with an illustrative embodiment.

FIG. 39 is a perspective view of the base assembly in accordance with an illustrative embodiment.

FIG. 40 is a top view of a first base end of the base assembly of the vehicle station in accordance with an illustrative embodiment.

FIG. 41 is a front view of the first base end of the base assembly in accordance with an illustrative embodiment.

FIG. 42 is a bottom view of the first base end of the base assembly in accordance with an illustrative embodiment.

FIG. 43 is a left side view of the first base end of the base assembly in accordance with an illustrative embodiment.

FIG. 44 is a perspective view of the first base end of the base assembly in accordance with an illustrative embodiment.

FIG. 45 is a top view of a base section of the base assembly of the vehicle station in accordance with an illustrative embodiment.

FIG. 46 is a bottom view of the base section of the base assembly in accordance with an illustrative embodiment.

FIG. 47 is a front view of the base section of the base assembly in accordance with an illustrative embodiment.

FIG. 48 is a left side view (the left and right sides can be mirror images) of the base section of the base assembly in accordance with an illustrative embodiment.

FIG. 49 is a perspective view of the base section of the base assembly in accordance with an illustrative embodiment.

FIG. 50 is a top view of a second base end of the base assembly of the vehicle station in accordance with an illustrative embodiment.

FIG. 51 is a bottom view of the second base end of the base assembly in accordance with an illustrative embodiment.

FIG. 52 is a perspective view of the second base end of the base assembly in accordance with an illustrative embodiment.

FIG. 53 is a bottom view of an assembled base assembly of a bicycle station in accordance with an illustrative embodiment.

FIG. 54 is a top view of a bicycle station in a first configuration in accordance with an illustrative embodiment.

FIG. 55 is a top view of a bicycle station in a second configuration in accordance with an illustrative embodiment.

FIG. 56 is a top view of a bicycle station in a third configuration in accordance with an illustrative embodiment.

FIG. 57 is a block diagram of a bicycle computer and a power generating hub assembly in accordance with an illustrative embodiment.

FIG. 58 is a block diagram of a bicycle tracking computer in accordance with an illustrative embodiment.

FIG. 59 is a block diagram of a memory of the bicycle tracking computer and a number of parameters stored therein in accordance with an illustrative embodiment.

FIG. 60 is a block diagram depicting communications between a kiosk, bicycle tracking computers, and a remote server in accordance with an illustrative embodiment.

FIG. 61 is a flowchart depicting operations performed by a vehicle station system to rent and monitor bicycles in accordance with an illustrative embodiment.

FIG. 62 is a diagram of system interchangeability in accordance with an illustrative embodiment.

FIG. 63 is a block diagram of a memory of the kiosk and example parameters and data records stored therein in accordance with an illustrative embodiment.

FIG. 64 is a diagram of a ride map in accordance with an illustrative embodiment.

FIG. 65 is a block diagram depicting dock communication in accordance with an illustrative embodiment.

FIG. 66 depicts a computing system of a bicycle dock in accordance with an illustrative embodiment.

### DETAILED DESCRIPTION

Described herein are vehicle station systems and methods of operating such systems. Although the embodiments are primarily described with reference to bicycles, it is to be understood that other vehicles may be used in alternative embodiments, such as mopeds, motorcycles, automobiles, scooters, segways, skateboards, etc.

Various embodiments of vehicle station systems are described herein. For example, one illustrative embodiment is related to an apparatus including a configurable vehicle docking station. The configurable vehicle docking station can be secured by at least one cable threaded through bases of the configurable vehicle docking station. Another illustrative embodiment is related to an apparatus including a kiosk that can include a dual frequency card reader. The dual frequency card reader can include a first antenna operating at a first frequency and a second antenna operating at a second frequency. Another illustrative embodiment is related to an apparatus for a bicycle. The apparatus can be a rack that attaches to the steerer stem or handlebars of the bicycle. The apparatus can include a platform area and a front side that can tilt out to make room for goods and can tilt in to stow. Yet another illustrative embodiment is related to a kiosk with a solar panel mount. The solar panel mount can include a first pole and a second pole. The ends of the first pole and the second pole can each have a knuckle joint that connects the first pole and the second pole to the solar panel. These embodiments are described in more detail below.

In an illustrative embodiment, the vehicle station system can include a bicycle tracking system. A bicycle tracking system and communication hub can include one or more bicycles and one or more communication hubs or kiosks configured to operably communicate with the one or more bicycles. In particular, the bicycle tracking system includes a number of bicycles associated with one or more kiosks located over a predetermined area such as a city or other such location/region. Moreover, the bicycle tracking system may include a number of kiosks located at various locations across the predetermined area and which may be in operable communication with one another such that data may be transferred between the bicycles and any one of the kiosks. In this manner, a user may rent a bicycle at a first kiosk and return the bicycle at a second, different kiosk and still maintain the trip data associated with his or her use of the bicycle. In an alternative embodiment, kiosks may not be used. In such an embodiment, the docks which secure the bicycles to the station can perform the communication and tracking operations, as discussed below. In some embodiments, the bicycle tracking system can also be incorporated into vehicles (e.g., maintenance/support vehicles) that travel to the vehicle station system, battery charging lockers that are proximate to the vehicle station system, and/or other street furniture (e.g. benches, waste receptacles, sculptures, signs, etc.) that is proximate to the system.

In another illustrative embodiment, each of the bicycles used in the system can include a bicycle computer or similar element for recording data associated with the riding and the usage of the bicycles. The bicycle computers may include a global positioning satellite (GPS) device coupled to the bicycles or otherwise carried by the bicycles to record trip data such as, for example, longitude, latitude, speed, location, distance traveled, and the like. The GPS device can be an active GPS device. The GPS device may be configured to record the information during the course of the ride and store the recorded information in the bicycle computer memory. At the completion of a user's ride, the GPS device (or bicycle computer) may be configured to transmit, either wirelessly or through a wired connection, the trip data to a kiosk/dock of the system at the return location. The GPS data may additionally be used by the tracking system for locating bicycles that have not been returned or which may have been removed without authorization. The bicycles may additionally include an identification element such as an radio frequency identification (RFID) tag or other chip located on or in the bicycle (or otherwise carried by the bicycle) for uniquely identifying each of the bicycles of the tracking system.

The vehicle station system can include a base, one or more kiosks, and bicycle docks. The kiosk may be in the form of a bicycle station kiosk. The kiosk may be in operable electronic communication with a parking rack configured to securely hold the bicycles. In such an embodiment, the base and docks can be configured as a parking rack. The parking rack may include one or more parking spaces/docks including supports for securing the bicycle to the parking spaces. The kiosk can include a kiosk computer, which is configured to receive the GPS data from the bicycle computer. The kiosk computer may include a transmitter for transmitting the GPS data and/or other data from a given user's ride to an enterprise server or other such centralized server. In an alternative embodiment, each dock at a station can include the functionality of the kiosk such that the kiosk can be eliminated from the system.

The enterprise server can be configured to associate the data received from the kiosk computer with a particular user's profile. Moreover, the enterprise server may be configured to aggregate the user's trip data with previously collected trip data. Further, the enterprise server may be configured to display to the user and/or operators of the bicycle tracking system ride map data, which may then be transmitted to the user in a predetermined manner via a network connection such as via the Internet. The user may use the ride map data to track his or her ride performance or characteristics and may share the data via social networking tools like, for example, Facebook®, Twitter®, or over e-mail. Understandably, the ride map data may also be transportable via a portable storage device such as a universal service bus (USB) drive or the like so that the user may take his or her data from place to place. The kiosk and/or the parking racks may include transceivers or other communication hardware/software for communicating with the identification element of the individual bicycles. In this way, the system may determine when a given bicycle has been removed from or returned to the parking rack to thereby track whether the bicycle is available for renting.

In this way, the bicycle tracking system may be used to graphically illustrate overall system metrics and provide operators of the bicycle tracking system with information related to the usage of the bicycles and the kiosks. The operators of the bicycle tracking system can use this information to determine when a given bicycle is in need of repair or periodic maintenance and/or whether a particular vehicle station location needs more or less infrastructure. For example, the bicycle tracking system may assist operators in determining the best locations for locating the stations in a given area.

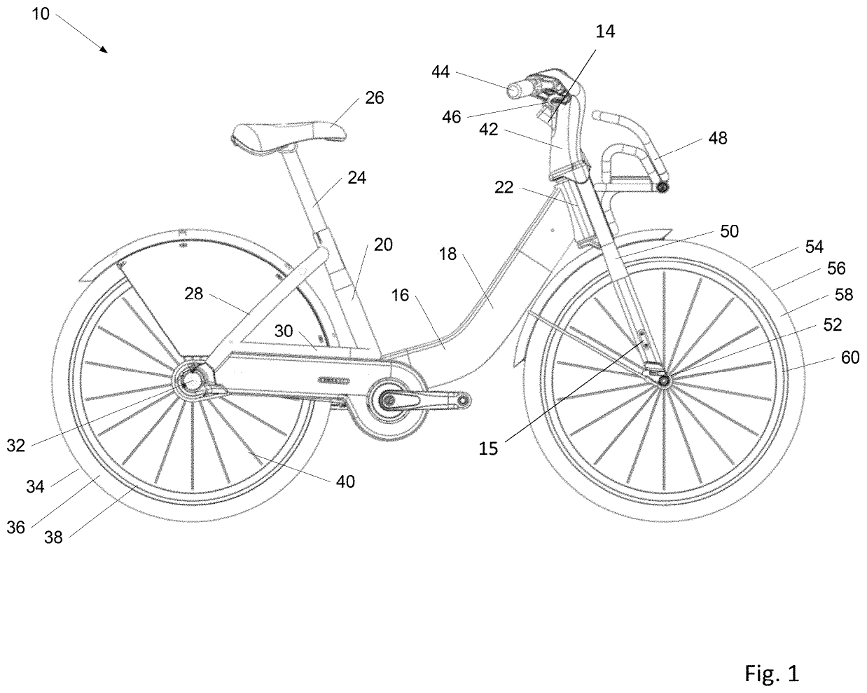

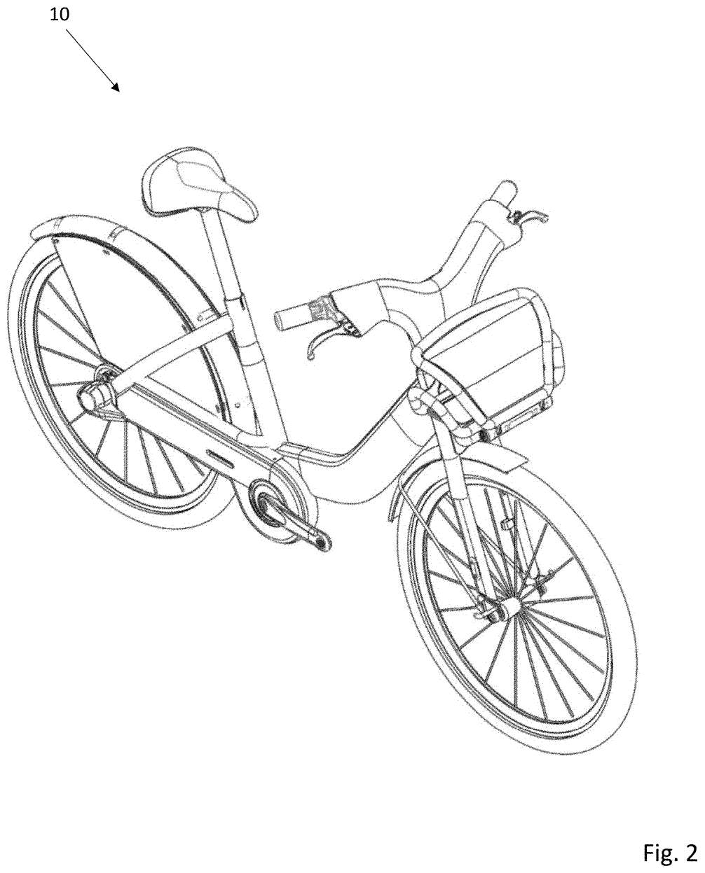

Referring now to the drawings and initially to FIGS. 1-7, a bicycle 10 for use in a vehicle station system is shown. Specifically, FIG. 1 is a side view of a bicycle 10 in accordance with an illustrative embodiment. FIG. 2 is a perspective view of the bicycle 10 of FIG. 1 in accordance with an illustrative embodiment. The bicycle 10 can include a bicycle computer 14 mounted on, coupled to, or otherwise carried by the bicycle 10. The bicycle can further include a unique identification element 15, which may be coupled to or otherwise carried by or in the bicycle 10. The identification element 15 may be in the form of an RFID chip, tag, or similar element configured to provide the bicycle 10 with a unique identifier for tracking by the tracking system. In one embodiment, the identification element is a RFID chip disposed in the fork of the bicycle 10. Alternatively, the identification element can be positioned elsewhere in/on the bicycle.

The bicycle 10 can further include a power generating hub assembly coupled to the front hub of the bicycle 10 for transmitting power to the bicycle computer 14 during riding for charging a battery of the bicycle computer during use. The power generating hub assembly may be incorporated into the hub assembly and integrated therein in its entirety. In particular, the hub assembly may be a standard pedal-operated power generator of the kind generally known in the art such as a direct current (DC) dynamo. The hub assembly may be operably coupled with the bicycle computer for selectively providing power thereto as is generally understood in the art. In this manner, a battery may be automatically charged during use using user-driven power generation. The hub assembly may include a connector for coupling with a corresponding connector at a kiosk/dock for interaction therebetween to, for example, charge the battery at the dock. Moreover, the hub assembly may be configured to power additional components of the bicycle 10 such as a headlamp or other lighting assembly (not shown). In alternative embodiments, the bicycle 10 may include just a battery, or a different type of power generation system.

The bicycle 10 includes a frame 16 having a down tube 18 interconnected between a seat tube 20 and a head tube 22. A seat post 24 is telescopically secured within the seat tube 20 and has a seat 26 for supporting a rider supported at an upward end thereof. The seat post 24 is selectively adjustable to accommodate different heights of users of the bicycle 10. Although only down tube 18 laterally connects head tube 22 and seat tube 20, other bicycle frame configurations are envisioned such as those that may include a separate top tube extending between the head tube and the seat tube. As used herein, the term frame or bicycle frame is intended to encompass all such variations. A pair of seat stays 28 and chain stays 30 extends rearwardly from seat tube 20 and support a rear hub assembly 32 of bicycle 10. Chain stays 30 extend generally parallel to a chain (not shown) of the bicycle 10 and connect to the rear dropouts. A rear hub assembly 32 rotatably supports a rear wheel 34. Rear wheel 34 comprises a tire 36 secured to a rim 38. Rim 38 includes a plurality of spokes 40 interconnected with the rear hub assembly 32 for supporting the tire 36 of the wheel 34.

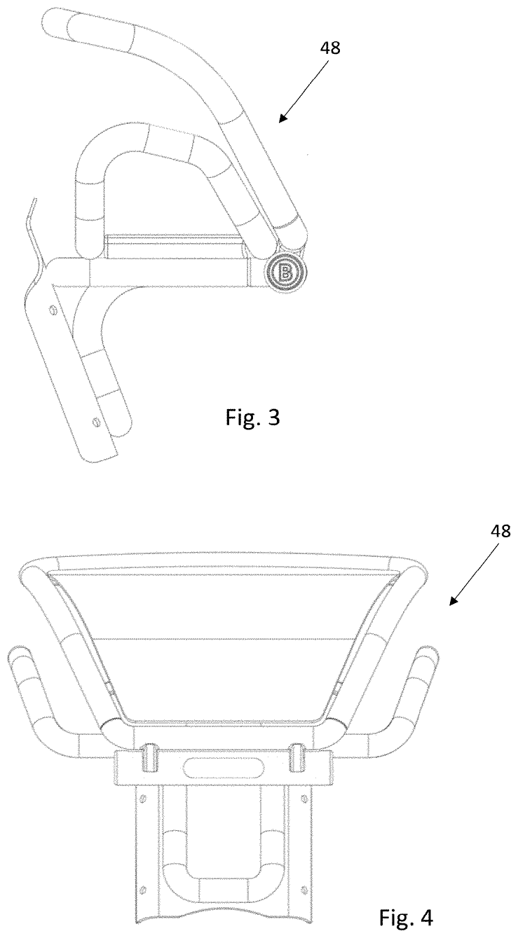

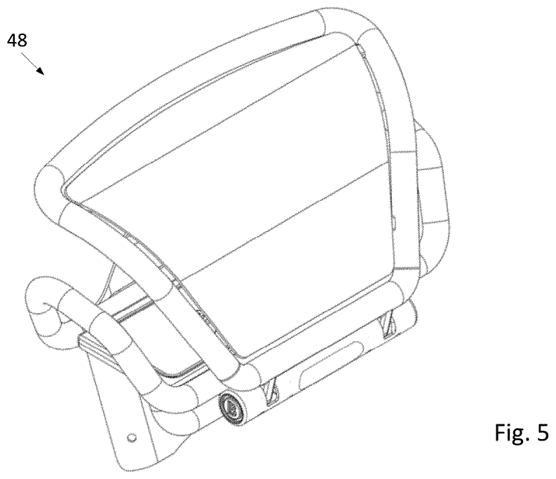

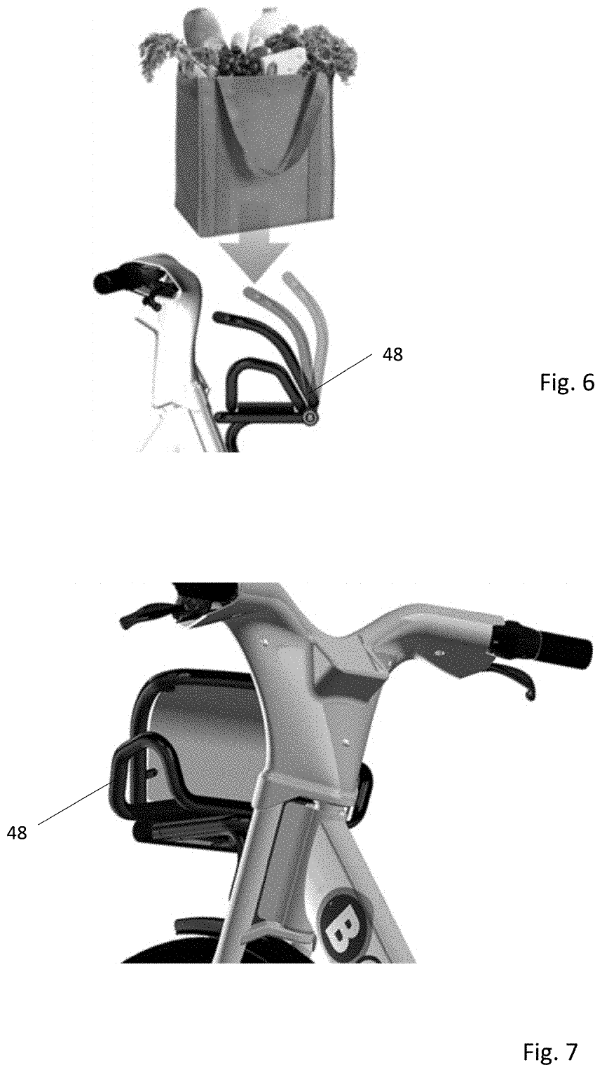

Referring to the forward end of bicycle 10, head tubes 22 support a handlebar assembly 42. Handlebar assembly 42 includes handlebars 44 for steering bicycle 10. Handlebar assembly 42 further includes handbrakes 46 which are operably coupled to brake assemblies (not shown) associated with one or both of the front and rear wheel assemblies. Bicycle 10 can include a rack 48 that is coupled to handlebar assembly 42 and head tube 22. Rack 48 can be adapted for storing or otherwise securing items. The rack 48 can be collapsed, and a user can easily see over the rack 48 of the bicycle 10 when the rack 48 is in the collapsed position. FIG. 3 is a side view of the rack 48 in accordance with an illustrative embodiment. FIG. 4 is a front view of the rack 48 of FIG. 3 in accordance with an illustrative embodiment. FIG. 5 is a perspective view of the rack 48 of FIG. 3 in accordance with an illustrative embodiment. FIG. 6 is a side view of the rack 48 depicting its adjustability to receive and hold items (e.g., a bag of groceries) in accordance with an illustrative embodiment. FIG. 7 is a rear perspective view of the rack 48 and a handlebar of the bicycle in accordance with an illustrative embodiment.

Head tube 22 may be constructed as a pair of supports configured for supporting a bottom portion of rack 48, or alternatively, head tube 22 may comprise a single tube like those generally known in the art. A pair of fork blades 50 extend downward relative to head tube 22 and are coupled to a front hub assembly 52 of the front wheel assembly 54. The hub assembly 52 rotatably supports front wheel 56. Front wheel 56 includes a tire 58 that is supported on a rim 60. Rim 60 includes a plurality of spokes 62 that extend radially between rim 60 and the front hub assembly 52. In alternative embodiments, the bicycles used with the proposed system may include a number of different configurations and/or additional components. For example, in alternative implementations, the bicycle 10 may include different frame, wheel, support, and/or suspension features and structures.

The bicycle 10 can also include various cables/wires to connect components and to control the bicycle. For example, the bicycle 10 can include wiring that connects the bicycle battery to a power generating hub assembly, one or more brake cables, one or more shifting cables, wiring to connect the bicycle computer and other accessories (e.g., integrated lights, etc.) to the battery and/or power generating hub assembly, etc. The cables/wires of the bicycle 10 can be routed internally through frame 16. Advantageously, routing the cables/wires through the frame protects them from weathering and abuse.

The bicycle computer 14 can be mounted in the handlebar assembly 42. In particular, the bicycle computer 14 can be housed within a compartment formed in the handlebar assembly 42. The handlebar assembly 42 can include a cover over the compartment that houses the bicycle computer. The cover may be configured to be selectively accessed by an operator of the tracking system for maintenance or the like. The cover can be configured to prevent unauthorized access to the bicycle computer such that the bicycle computer is protected from theft, vandalizing, and tampering. Moreover, the cover protects the bicycle computer from damage from the elements, e.g., rain, snow, debris, etc. As discussed herein, the bicycle computer 14 can include a GPS sub-system, a processor, a memory, a transceiver, and an interface in some embodiments.

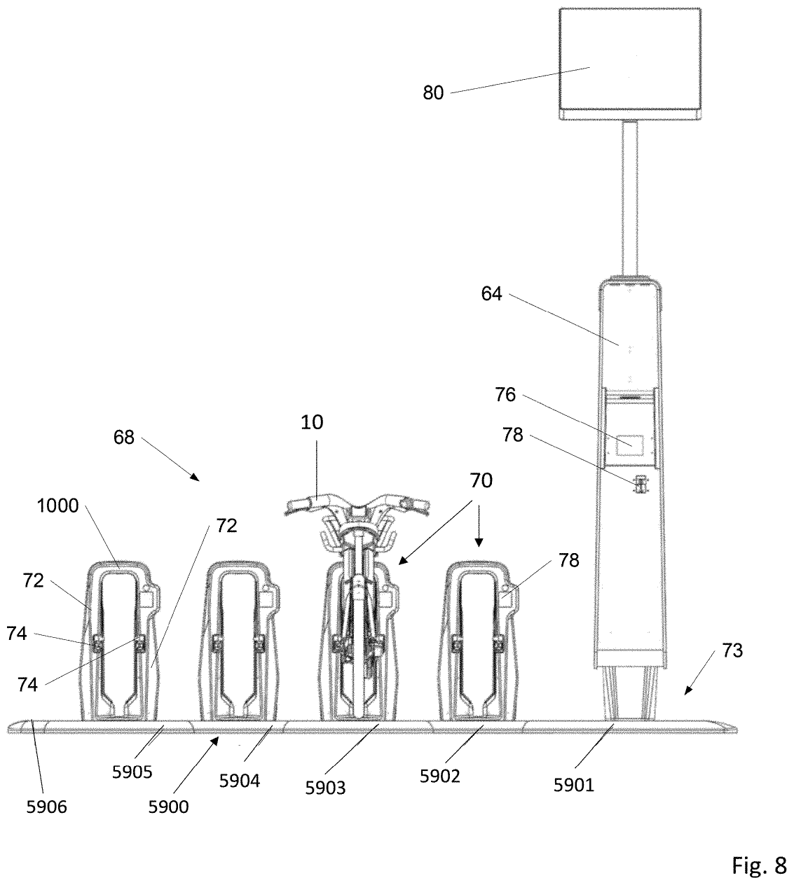

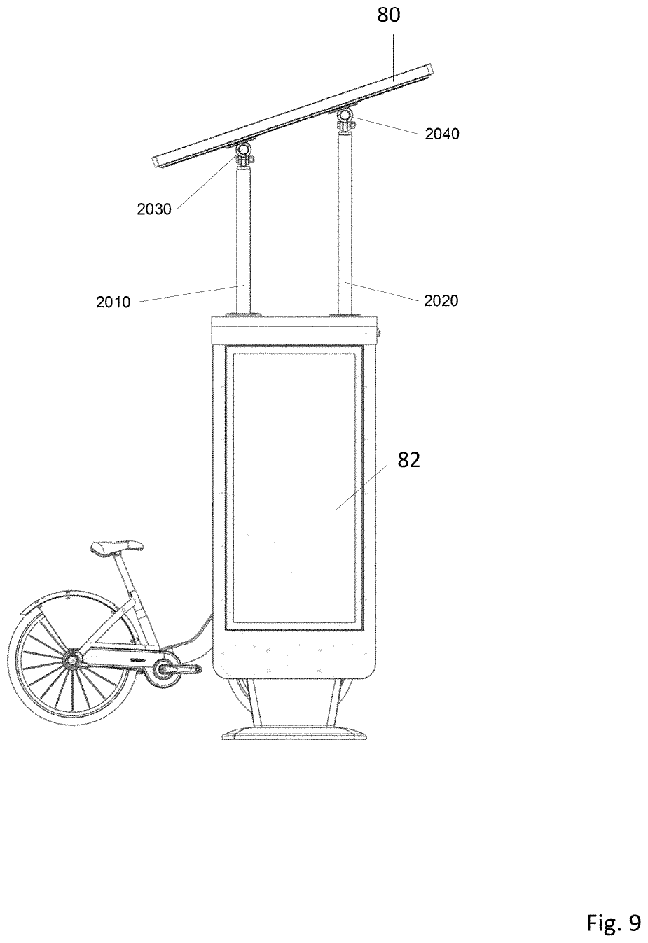

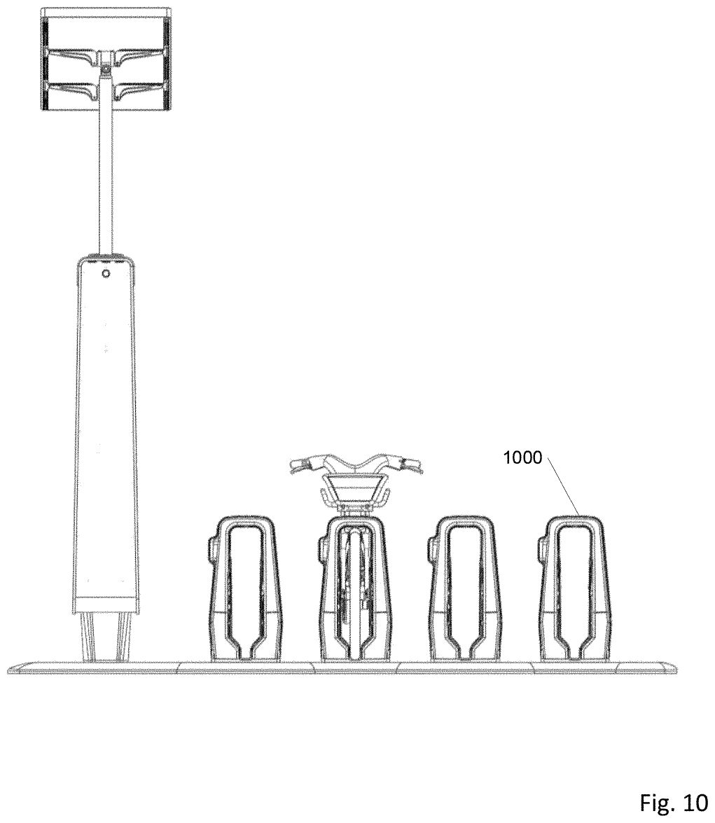

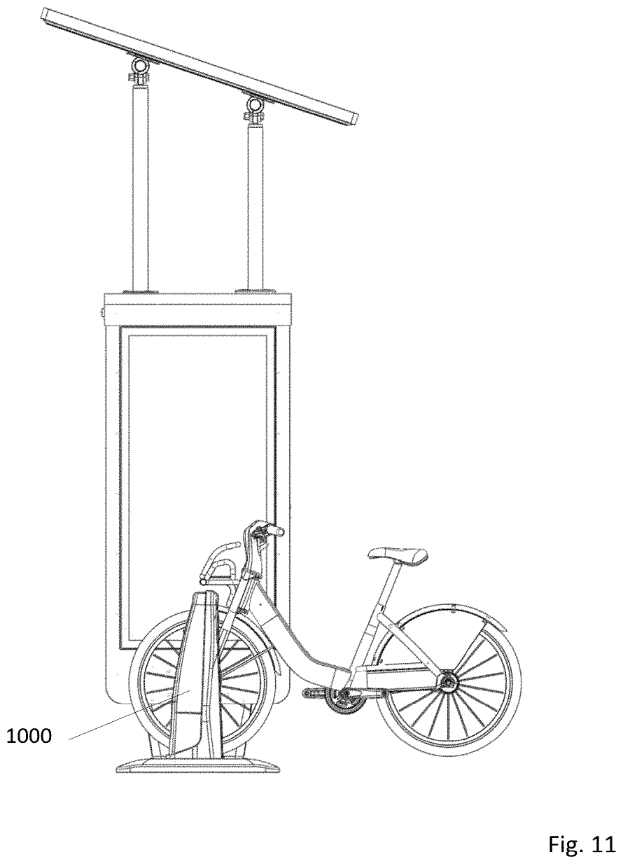

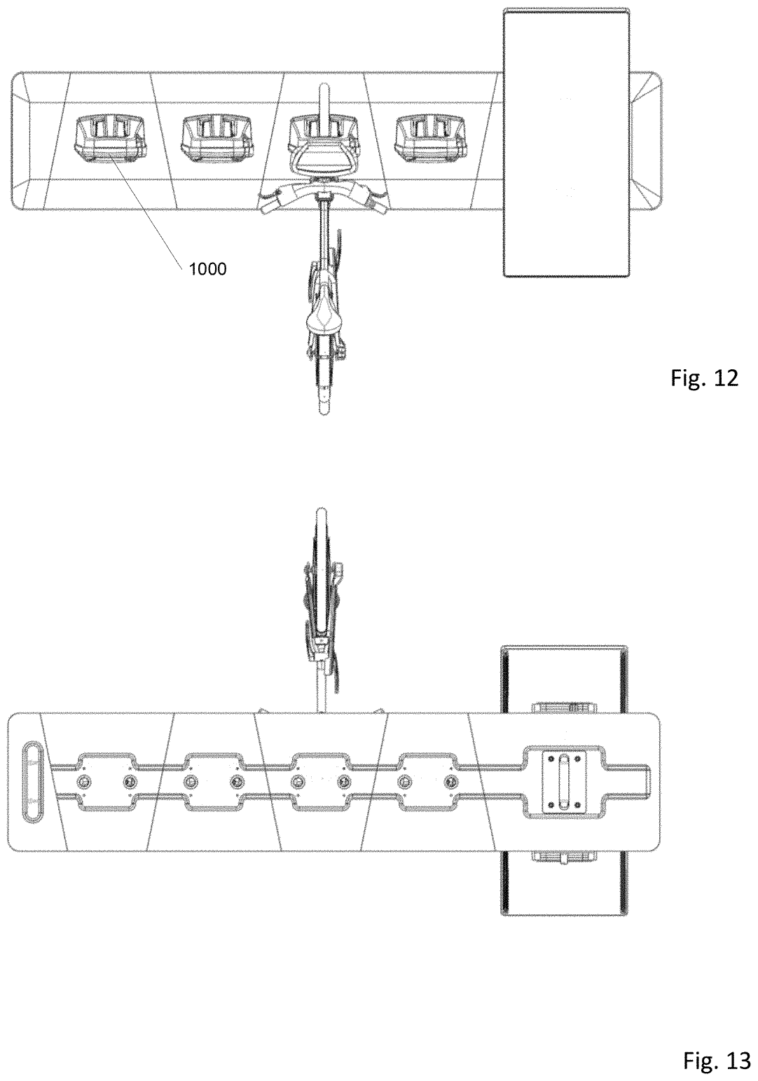

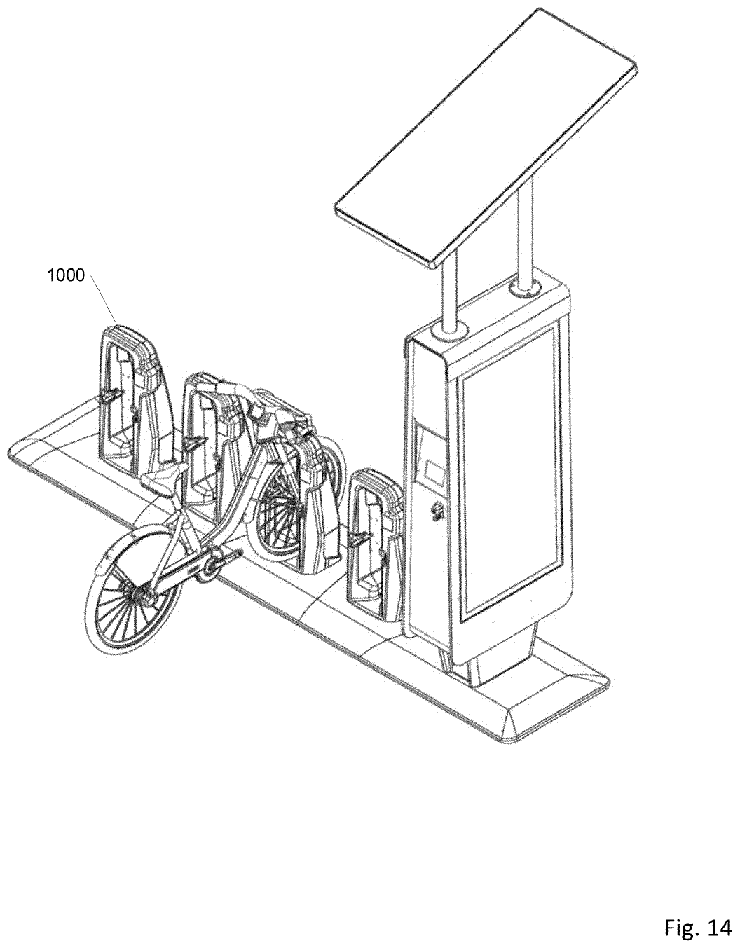

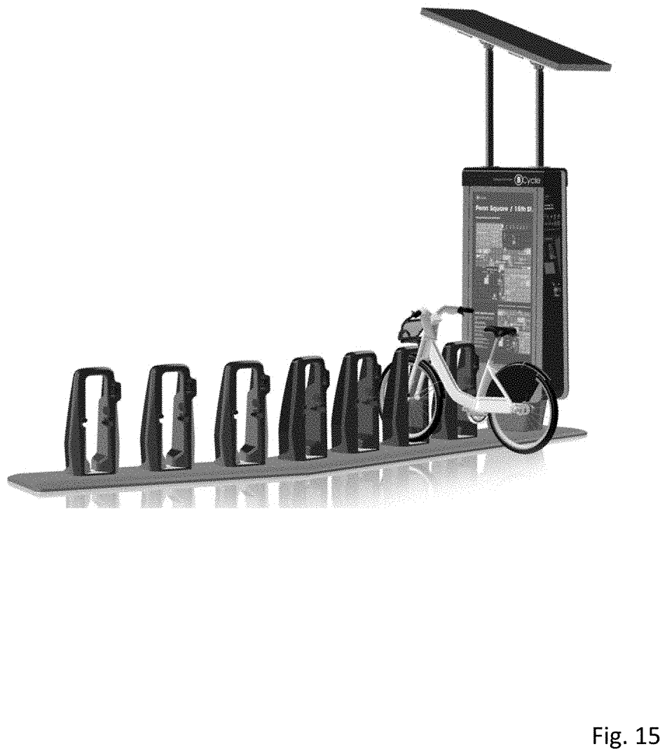

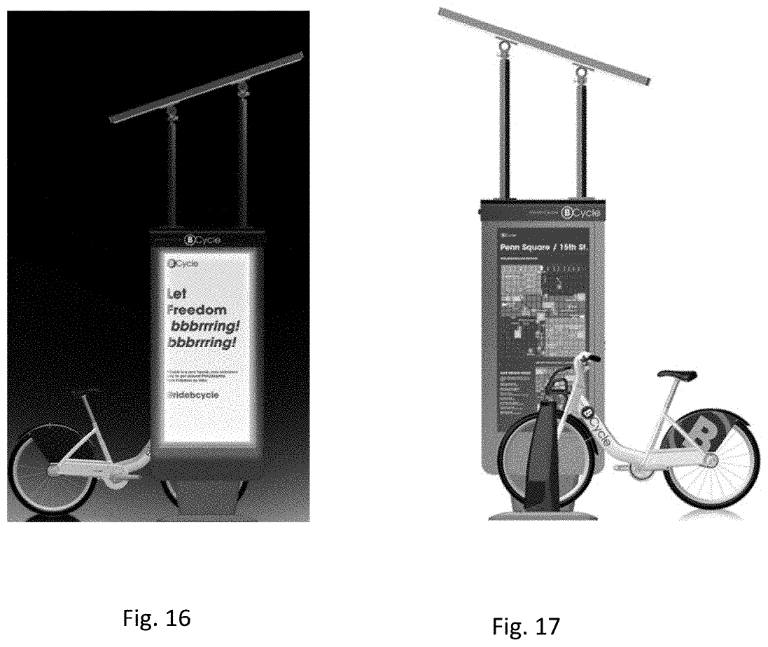

As discussed, the bicycles are housed at one of a number of vehicle station systems that allow users (i.e., riders) to check out or rent the bicycles for a duration of time. FIG. 8 is a front view of a vehicle station system in accordance with an illustrative embodiment. FIG. 9 is a right side view of the vehicle station in accordance with an illustrative embodiment. FIG. 10 is a rear view of the vehicle station in accordance with an illustrative embodiment. FIG. 11 is a left side view of the vehicle station in accordance with an illustrative embodiment. FIG. 12 is a top view of the vehicle station in accordance with an illustrative embodiment. FIG. 13 is a bottom view of the vehicle station in accordance with an illustrative embodiment. FIG. 14 is a perspective view of the vehicle station in accordance with an illustrative embodiment. FIG. 15 is a perspective view of a bicycle station in accordance with another illustrative embodiment. FIG. 16 is a side view of a light-emitting diode (LED) advertising display of a bicycle station in accordance with an illustrative embodiment. FIG. 17 is a side view of a map display of a bicycle station in accordance with an illustrative embodiment.

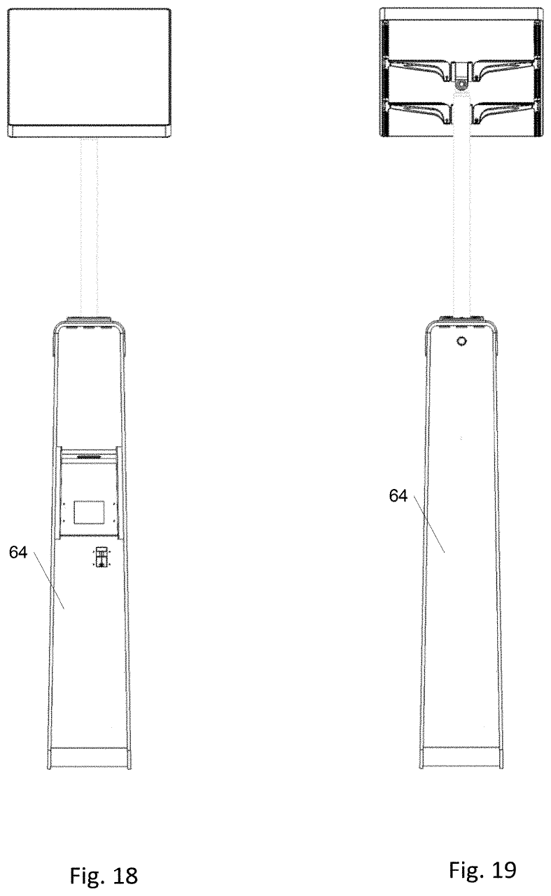

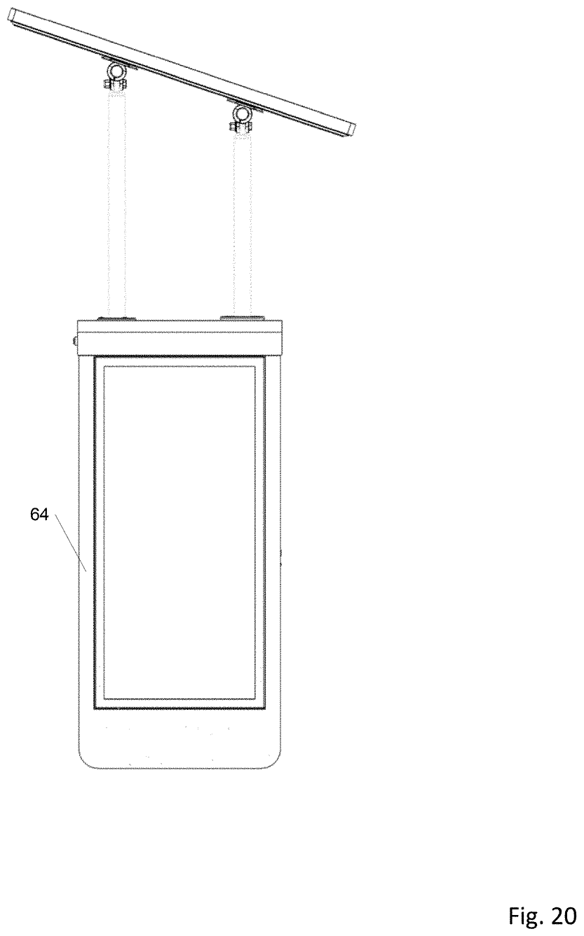

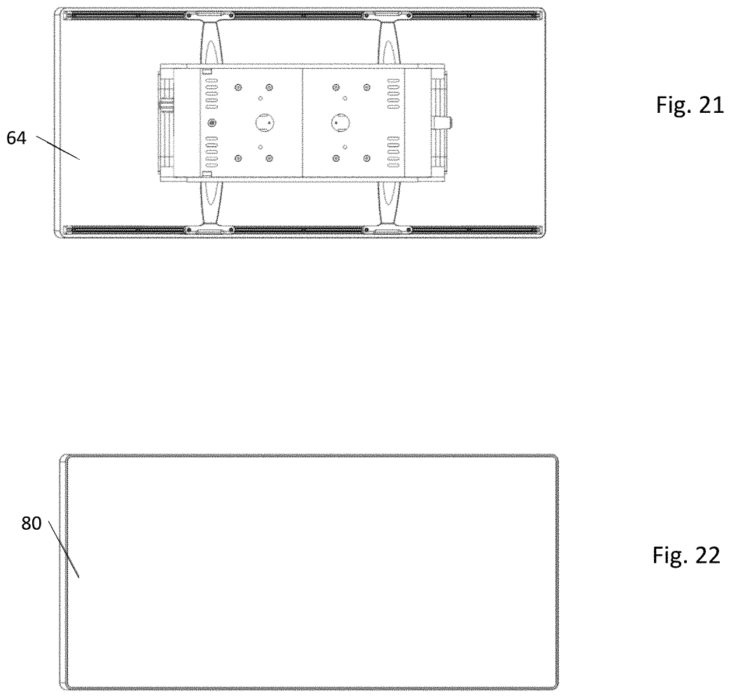

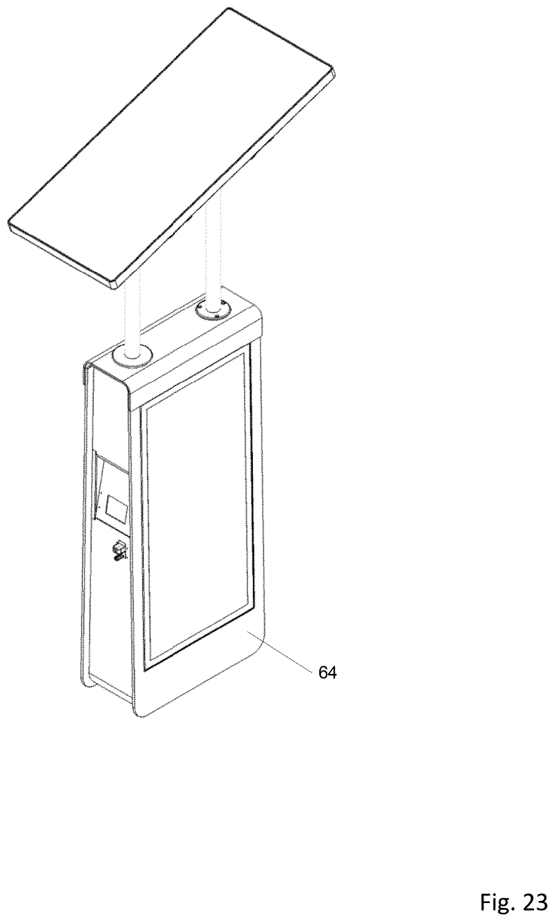

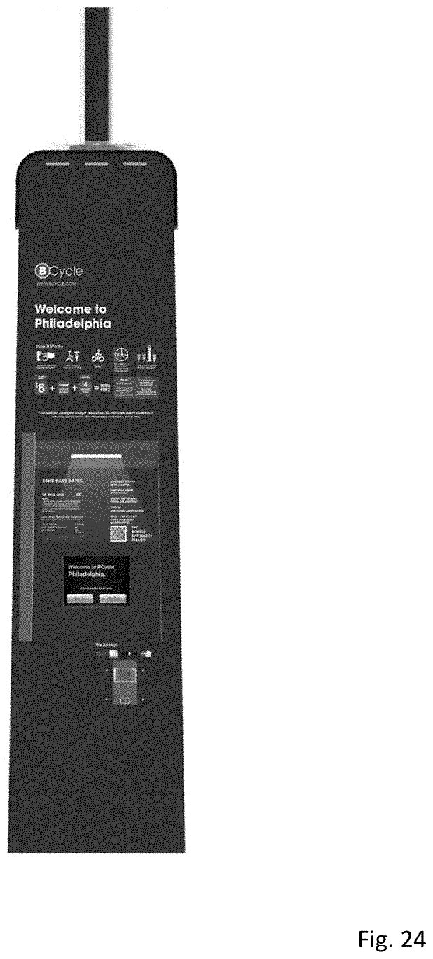

In an illustrative embodiment, the vehicle station system includes a kiosk 64, a plurality of docks to receive/release bicycles, and a base assembly to support the system. As noted, some embodiments may not include the kiosk. Additionally, some implementations may not include the base assembly. FIG. 18 is a front view of a kiosk 64 of the vehicle station in accordance with an illustrative embodiment. FIG. 19 is a rear view of the kiosk 64 in accordance with an illustrative embodiment. FIG. 20 is a side view of the kiosk 64 in accordance with an illustrative embodiment. In some embodiments, the left and right sides of the kiosk 64 can be mirror images. Alternatively, the sides of the kiosk 64 can differ in the number, size, and/or configuration of display elements 82 that they include. FIG. 21 is a bottom view of the kiosk 64 in accordance with an illustrative embodiment. FIG. 22 is a top view of the kiosk 64 in accordance with an illustrative embodiment. FIG. 23 is a perspective view of the kiosk 64 in accordance with an illustrative embodiment. FIG. 24 is a front view of a kiosk in accordance with another illustrative embodiment.

In one embodiment, the kiosk 64 can be in operable communication with a bicycle parking rack 68, which includes a number of parking spaces 70 for securely receiving a number of bicycles 10 associated with the tracking system. Specifically, each parking space includes a dock 1000, which is described in detail below. While the embodiment of FIG. 8 depicts 4 parking spaces, it is to be understood that fewer or additional parking spaces may be used in alternative embodiments, such as 1, 2, 12, 15, 24, 50, 100, etc. Each of the parking spaces 70 is defined by one or more support members 72 that form the dock 1000, which is supported on a platform 73 and includes a locking arrangement 74 for securely engaging a corresponding locking element of the bicycle 10. The locking arrangement 74 may be in operable communication with the kiosk 64 and the kiosk computer. In this way, the kiosk 64 can be configured to selectively release the locking arrangement 74 to enable a user to remove a bicycle for renting after receipt of payment or identification means at the kiosk or another location remote from the kiosk 64.

The kiosk 64 may include a display element 76 and a user authorization element 78. The user authorization element 78 may be configured to receive payment in the form of bills, coins, and credit or debit cards from a user wishing to rent one of the bicycles 10. The user authorization element 78 may further be configured to receive other identification means from a user. For instance, a user may be supplied with a membership card, token, fob, or other such element that is configured to operably interact with the user authorization element 78 so that when the user wishes to rent a bicycle 10 at a given kiosk, he or she may simply supply the user authorization element 78 with the necessary authorizing information about the user so that the user is able to access a bicycle 10 from the system. In this manner, users who wish to rent bicycles 10 on a regular basis may sign up either at the kiosk 64 or at another location remote from the kiosk such as over the Internet for receipt of a membership card or the like, which may be used to periodically rent bicycles 10 from the system. In this way, the user need not supply his or her payment information each and every time he or she wishes to rent a bicycle 10. Rather, payment may be made automatically upon interaction between the identification element (e.g., membership card or fob) and the kiosk 64, or the identification element may be preloaded with a number of credits for rental or any other such type of configurations may be used.

As shown, a user authorization element 78 can also be incorporated into each of the docks 1000 of the bicycle parking rack 68. Thus, in embodiments where the user has a card, fob, or other membership identifier, the user can retrieve a bicycle 10 by interacting with user authorization element 78 at the dock 1000, thereby bypassing interaction with the kiosk 64. The authorization element 78 can include an encryption device in some embodiments.

The display element 76 of the kiosk 64 may be configured to display information to the user concerning his or her rental of the bicycle 10 as may be desired. For example, the display element 76 may receive user inputs/commands and communicate to the user so as to instruct him/her on how to complete the rental process etc. Moreover, the display element 76 may be configured to communicate any other such information to the user as may be deemed important including weather conditions, bicycle paths in the vicinity, road closures, etc. The display element 76 can also display instructions for operating the kiosk, helpful tips on bicycle use, frequently asked questions, etc. Any type of display may be used.

The kiosk 64 may include a power supply element 80 such as a solar panel, which may be configured to supply a power source such as a battery with power and may be configured to periodically charge the power source as necessary. The kiosk 64 can also be powered by the electrical grid. The kiosk 64 may also include an information display element 82, which may be in the form of a standard sign or other display, which is configured to convey information, advertisements, and/or instructions to users. In addition, the display element 82 may provide a map of the area and identify where the user currently is and where he or she may find other stations of the system, bicycle trails, etc. The display element 82 may also convey suggested routes or other information to the user. FIGS. 16 and 17 depict display elements of the kiosk 64 that include an advertisement (FIG. 16) and cycling maps and information (FIG. 17).

The kiosk can be a weather-proof design including 20 year finishes and materials that will not rust. The kiosk can be made of, for example, stainless steel, plastic, and aluminum. The display element 82 and display element 76 can include backlit Ad/Map panels. The backlight can be implemented using LED lights. The display element 82 and display element 76 can be configured to be readable in the sunlight.

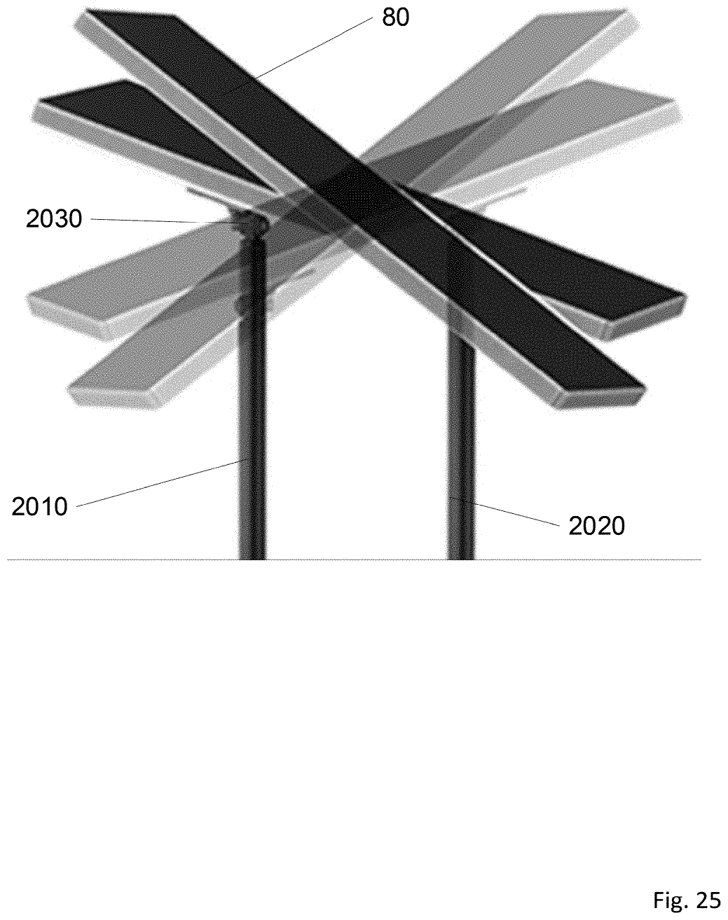

The power supply element 80 (e.g., solar panel) can be mounted to the kiosk 64 by a first pole 2010 and a second pole 2020. The first pole 2010 and the second pole 2020 can stow within the kiosk 64 such that each is independently adjustable in height. The kiosk 64 can include sleeves to receive the first pole 2010 and the second pole 2020. When the first pole 2010 and the second pole 2020 are adjusted to the desired heights, the sleeves can be compressed/tightened. Alternatively, the first pole 2010 and the second pole 2020 can include a series of holes along their lengths for adjustment. A first knuckle coupling 2030 can be fixed to the top of the first pole 2010. A second knuckle coupling 2040 can be fixed to the top of the second pole 2020. The power supply element 80 is fixed to the first knuckle coupling 2030 and the second knuckle coupling 2040. Maintenance personnel can adjust the first pole 2010 and the second pole 2020 as well as the first knuckle coupling 2030 and the second knuckle coupling 2040 to aim the power supply element 80 at the sun. In one embodiment, the first knuckle coupling 2030 and the second knuckle coupling 2040 can include a ball that is clamped upon. Advantageously, as shown in FIG. 25, the power supply element 80 can be rotated substantially 360 degrees from side to side and over a wide range from front to back. In one embodiment, a tracking system can be attached to the power supply element 80 to aim the power supply element 80 toward the sun automatically, without operator intervention. In an alternative embodiment, the system may also be hardwired to a power grid such that the power grid acts as the power source during times of low sun, etc. In an alternative embodiment, the power supply element 80 can be mounted to the base and/or to one or more of the docks 1000 of the system.

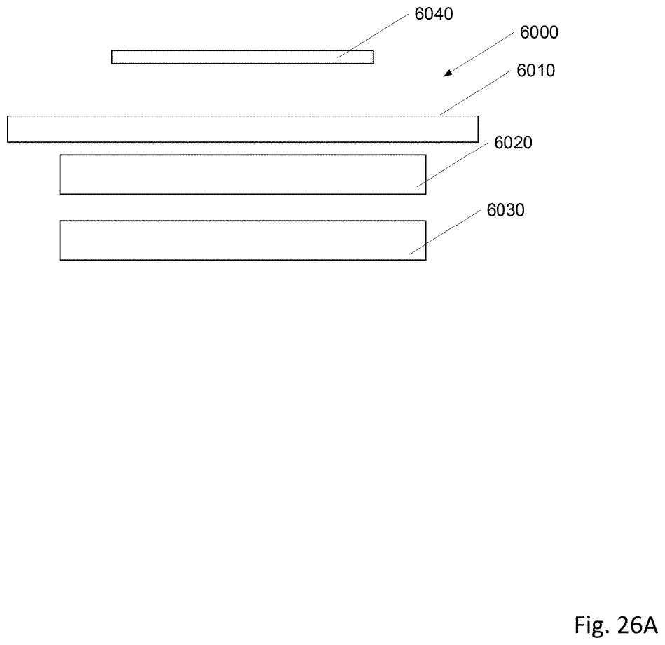

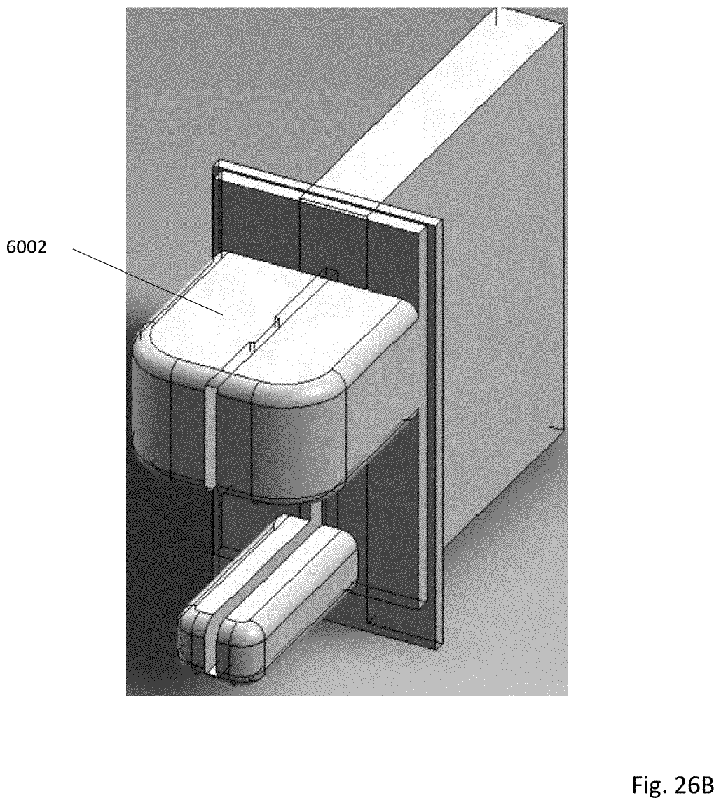

In an illustrative embodiment, the user authorization element 78 of the kiosk 64 and/or the dock 1000 can include multiple antennas. Referring now to FIG. 26A, a block diagram of a user authorization element 6000 including readers is shown. The readers can be card readers, fob readers, etc. The readers can also be capable of scanning a physical item (e.g., bar code or symbol) and/or communicating with a user device such as a smart phone. In the depicted embodiment, the user authorization element 6000 includes a first reader 6020 and a second reader 6030. Alternatively, fewer or additional readers may be used. The first reader 6020 and the second reader 6030 can be stacked against a protective surface 6010. The first reader 6020 can communicate at a first frequency, and the second reader 6030 can communicate at a second frequency. For example, the first frequency can be a Bluetooth frequency and the second frequency can be a near field communications (NFC) frequency. When a card 6040 or other item is placed near the protective surface 6010, the card 6040 can communicate with the appropriate card reader. The signal power of second reader 6030 can be greater than the signal power of first reader 6020 in order to account for attenuation through the first reader 6020. Alternatively, a different arrangement of the readers may be used such that they are equidistant from the protective surface 6010.

FIG. 26B depicts a user authorization element 6002 in the form of a card reader in accordance with another illustrative embodiment. The user authorization element 6002 includes a single card reader that is able to receive a physical card. The user authorization element 6002 can also be capable of wireless communication with a physical card and/or user device. The user authorization element 6002 can also include any of the other functionality described herein.

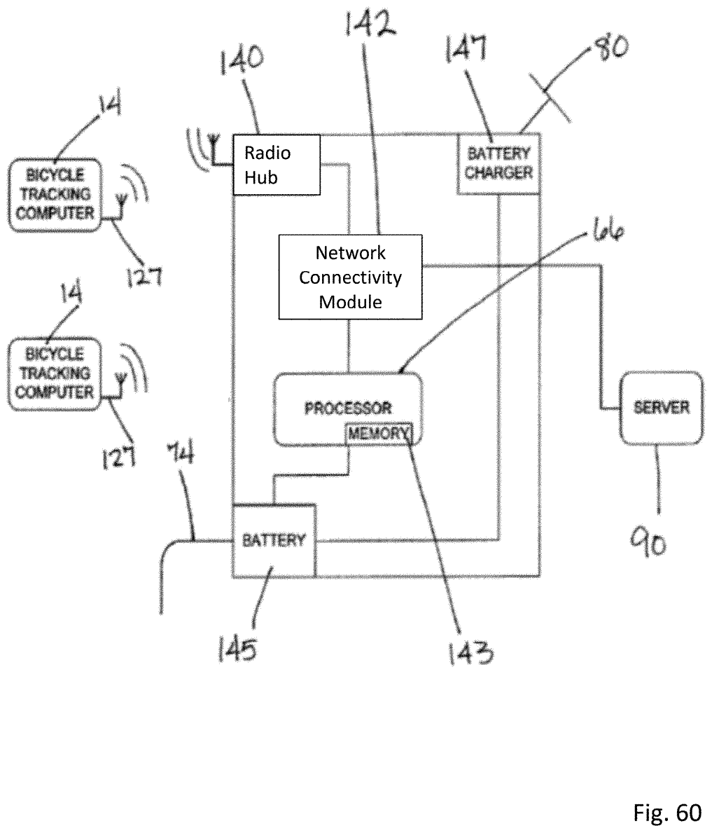

One or both of the kiosk 64 and the dock 1000 may also include one or more bicycle identification readers configured to operably interact with the identification element of the bicycle 10. For example, each dock 1000 of the parking rack 68 may include a bicycle identification reader. Alternatively, a single bicycle identification reader may be used for all bicycles associated with a the parking rack 68. In particular, the identification reader may be configured to transmit a signal in the direction of a bicycle 10 when the bicycle 10 is docked or undocked from the parking rack 68 to identify the bicycle 10 that is being returned or removed from the parking rack 68. In one embodiment, the reader receives a communication from the identification element in the bicycle 10 and electronically transmits the information to the kiosk 64 for relay to an enterprise server 90 (see FIG. 60) as will be discussed in additional detail herein. Alternatively, the reader can be the dock 1000 and the dock 1000 can directly communicate the information to the enterprise server 90. In an illustrative embodiment, the identification reader is an RFID reader of the kind generally known in the art.

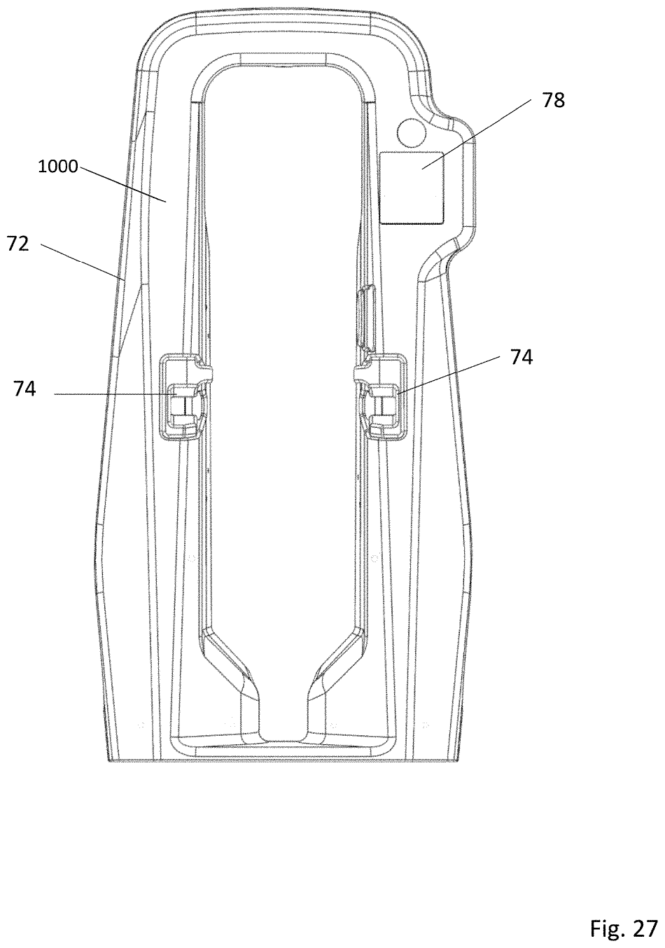

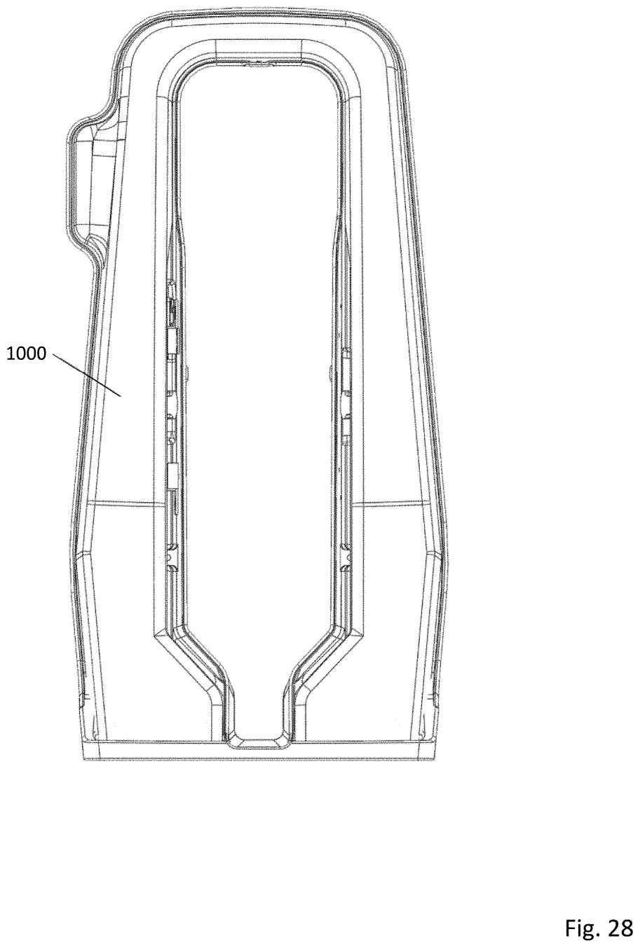

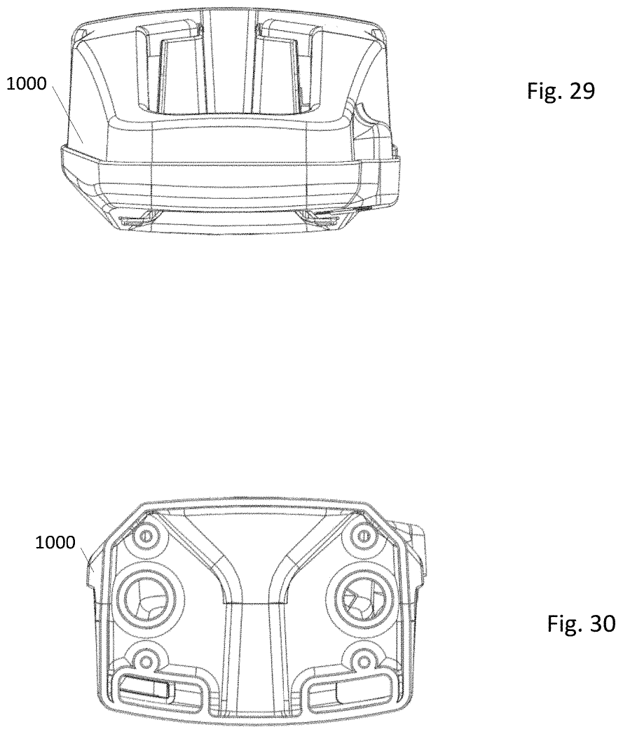

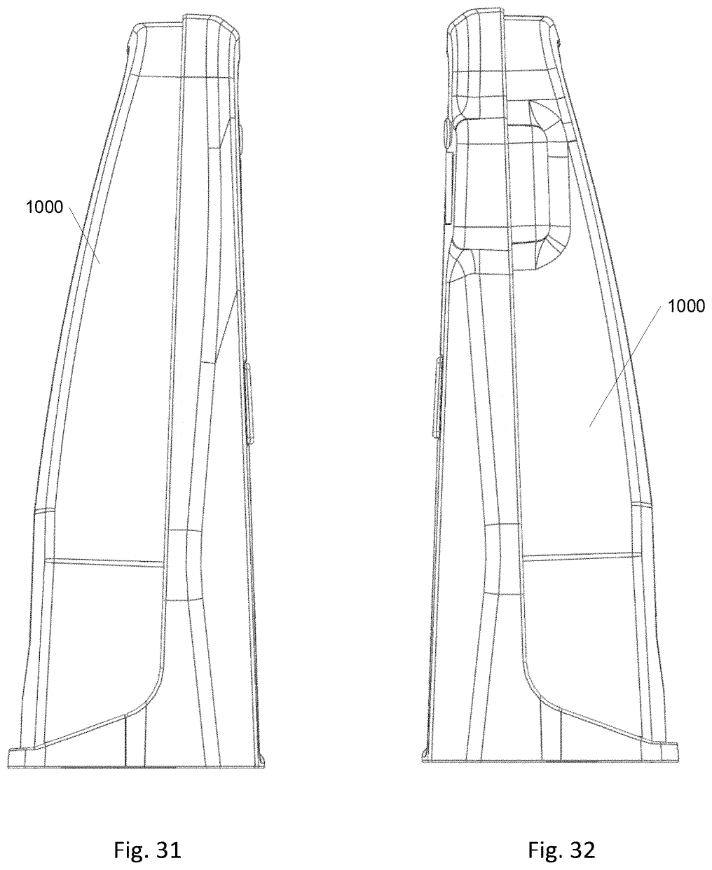

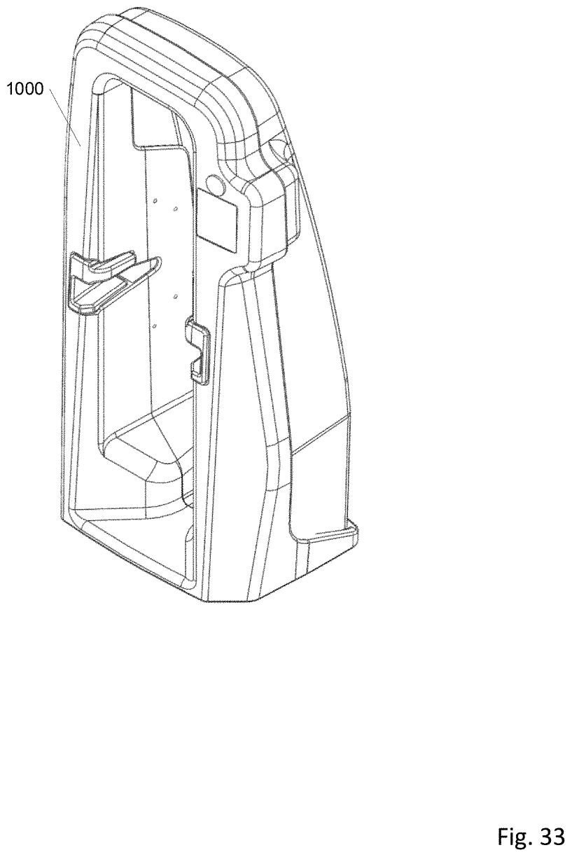

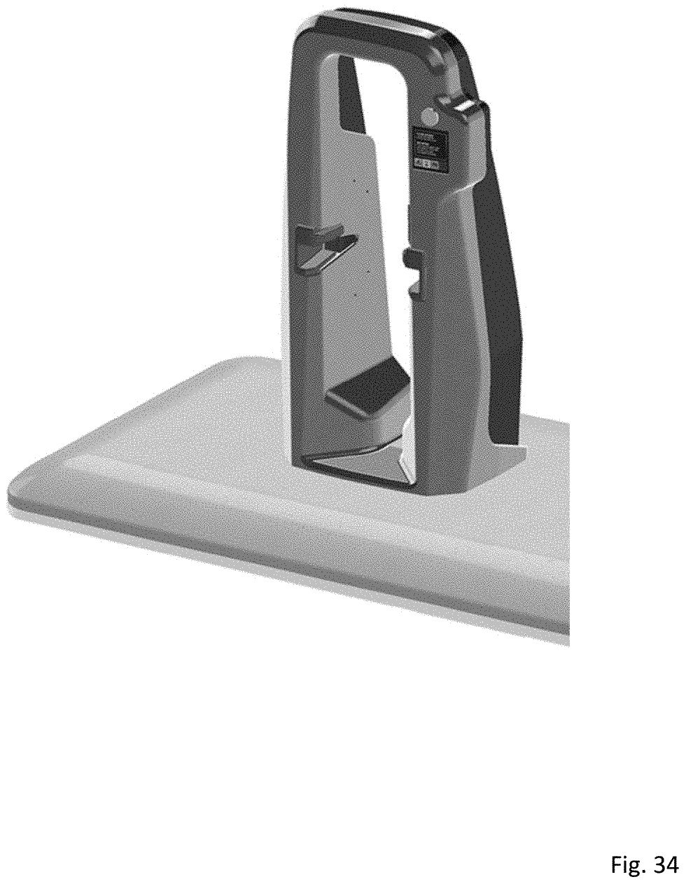

As discussed, the kiosk 64 can be in communication with a plurality of docks 1000 that are configured to receive/release bicycles. FIG. 27 is a front view of a dock 1000 of the vehicle station in accordance with an illustrative embodiment. FIG. 28 is a rear view of the dock 1000 of the vehicle station in accordance with an illustrative embodiment. FIG. 29 is a top view of the dock 1000 of the vehicle station in accordance with an illustrative embodiment. FIG. 30 is a bottom view of the dock 1000 of the vehicle station in accordance with an illustrative embodiment. FIG. 31 is a left side view of the dock 1000 of the vehicle station in accordance with an illustrative embodiment. FIG. 32 is a right side view of the second embodiment of the dock of the vehicle station in accordance with an illustrative embodiment. FIG. 33 is a perspective view of the dock 1000 of the vehicle station in accordance with an illustrative embodiment. FIG. 34 is a perspective view of a docking station in accordance with another illustrative embodiment.

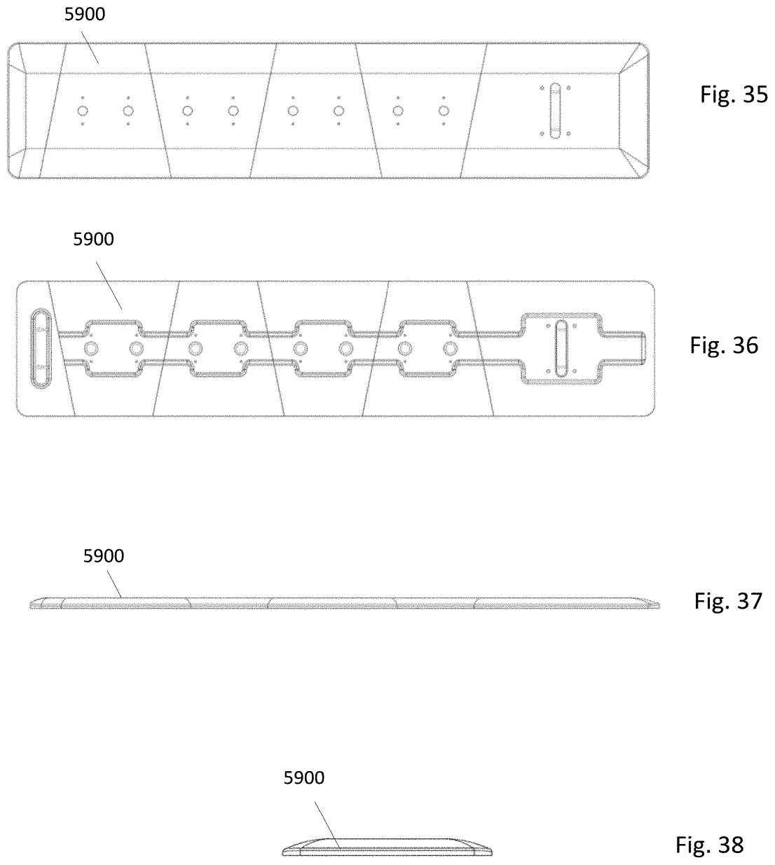

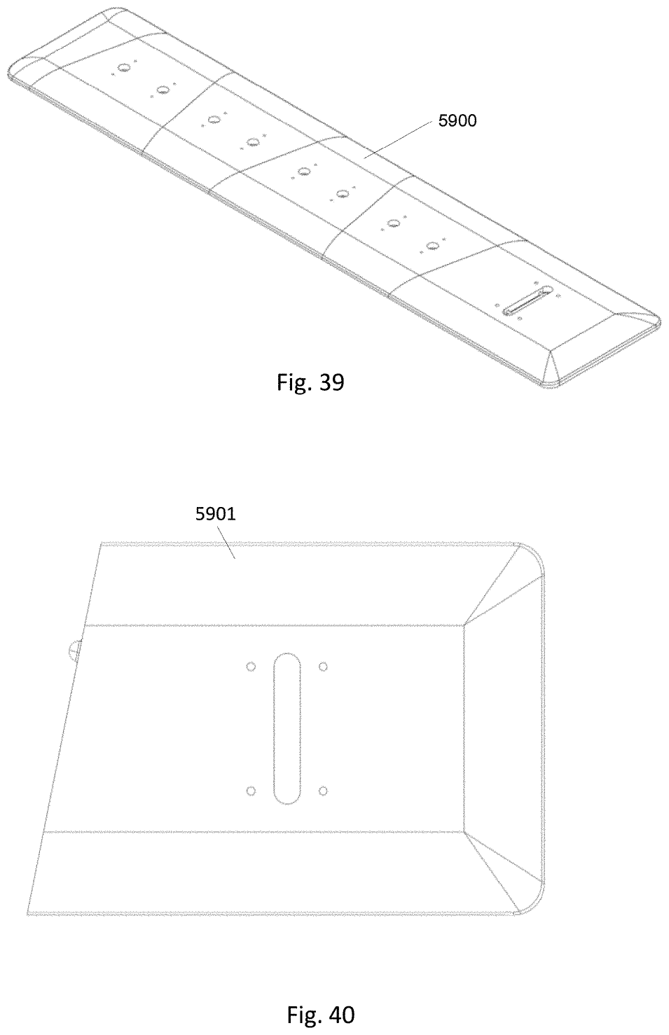

A plurality of docks 1000 can be mounted to a base assembly of the system, along with the kiosk 64 (if present). FIG. 35 is a top view of a base assembly 5900 of the vehicle station in accordance with an illustrative embodiment. FIG. 36 is a bottom view of the base assembly 5900 in accordance with an illustrative embodiment. FIG. 37 is a front view of the base assembly 5900 in accordance with an illustrative embodiment. It is noted that the rear of the base assembly can be the same as the base assembly shown in FIG. 10. FIG. 38 is a side view of the base assembly 5900 in accordance with an illustrative embodiment. In some embodiments, the left and right sides of the base assembly 5900 can be mirror images. FIG. 39 is a perspective view of the base assembly 5900 in accordance with an illustrative embodiment.

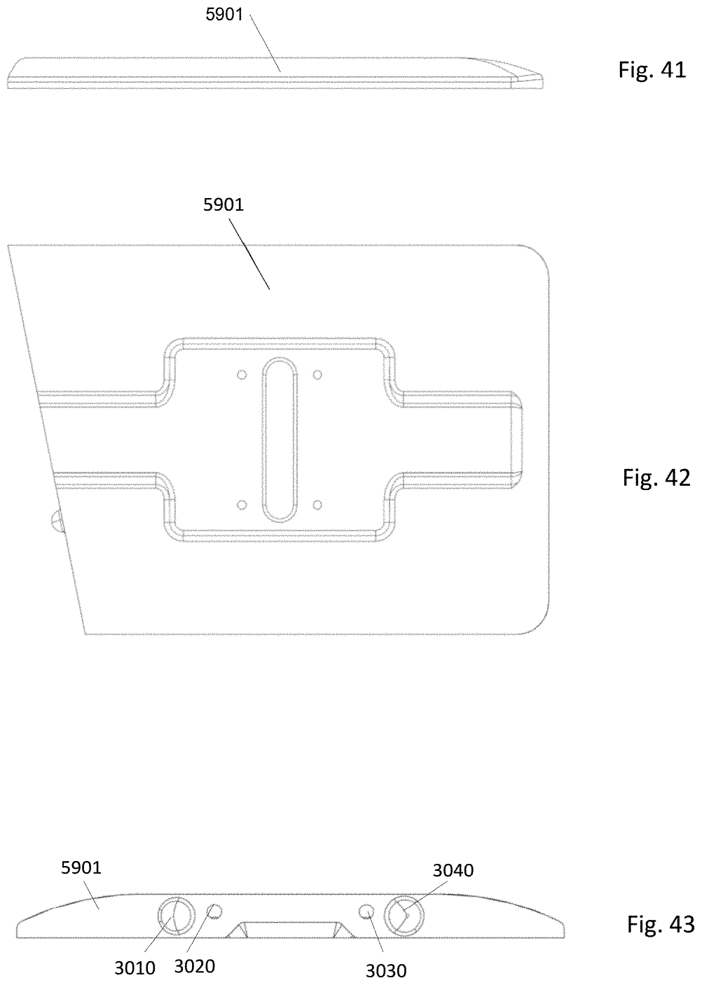

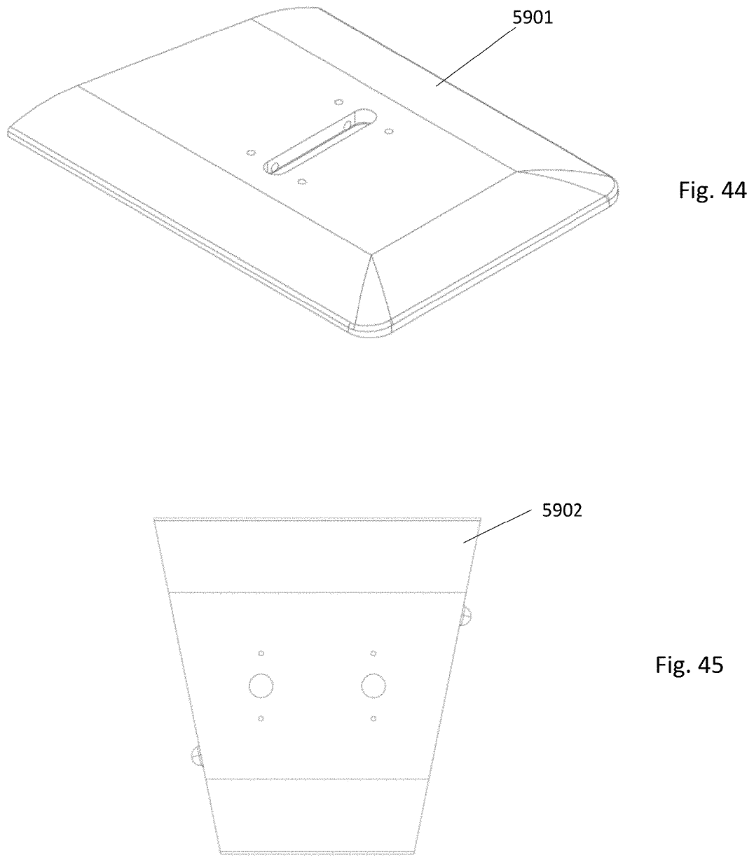

FIG. 40 is a top view of a first base end 5901 of the base assembly 5900 of the vehicle station in accordance with an illustrative embodiment. FIG. 41 is a front view of the first base end 5901 of the base assembly 5900 in accordance with an illustrative embodiment. It is noted that the rear can be the same as the base assembly shown in FIG. 10. FIG. 42 is a bottom view of the first base end 5901 of the base assembly in accordance with an illustrative embodiment. FIG. 43 is a left side view of the first base end 5901 of the base assembly 5900 in accordance with an illustrative embodiment. It is noted that the right side is shown in FIG. 38. FIG. 44 is a perspective view of the first base end 5901 of the base assembly 5900 in accordance with an illustrative embodiment.

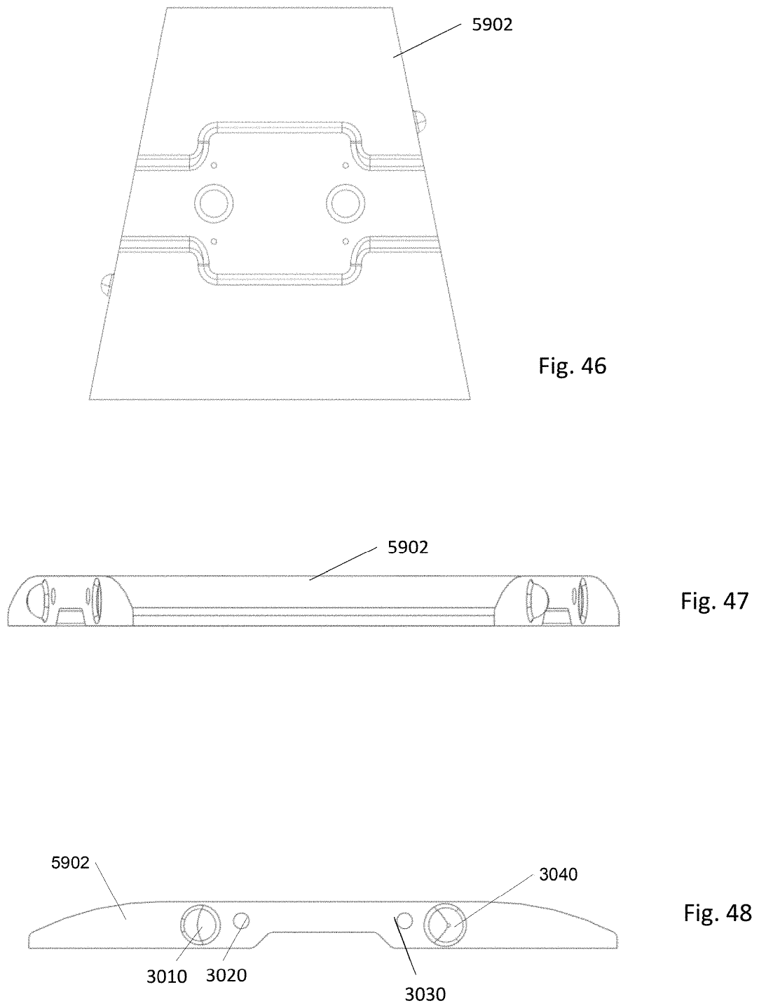

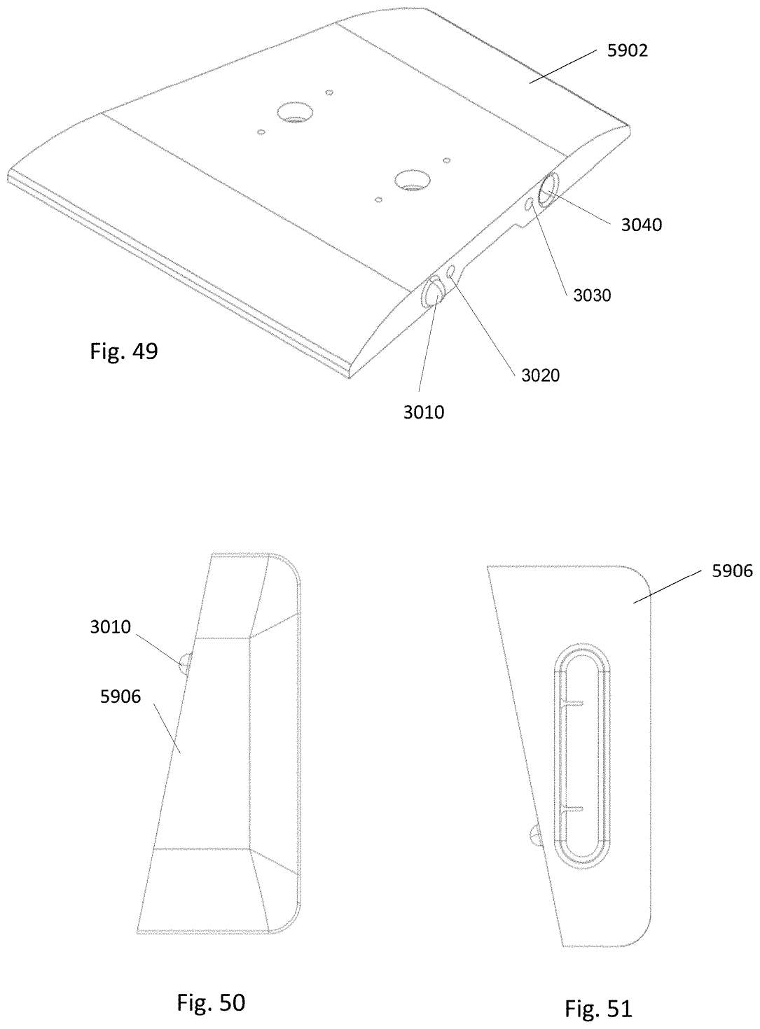

FIG. 45 is a top view of a base section 5902 of the base assembly 5900 of the vehicle station in accordance with an illustrative embodiment. FIG. 46 is a bottom view of the base section 5902 of the base assembly in accordance with an illustrative embodiment. FIG. 47 is a front view of the base section 5902 of the base assembly 5900 in accordance with an illustrative embodiment. It is noted that the rear can be the same as the base assembly shown in FIG. 10. FIG. 48 is a left side view (the left and right sides can be mirror images) of the base section 5902 of the base assembly 5900 in accordance with an illustrative embodiment. FIG. 49 is a perspective view of the base section 5902 of the base assembly 5900 in accordance with an illustrative embodiment.

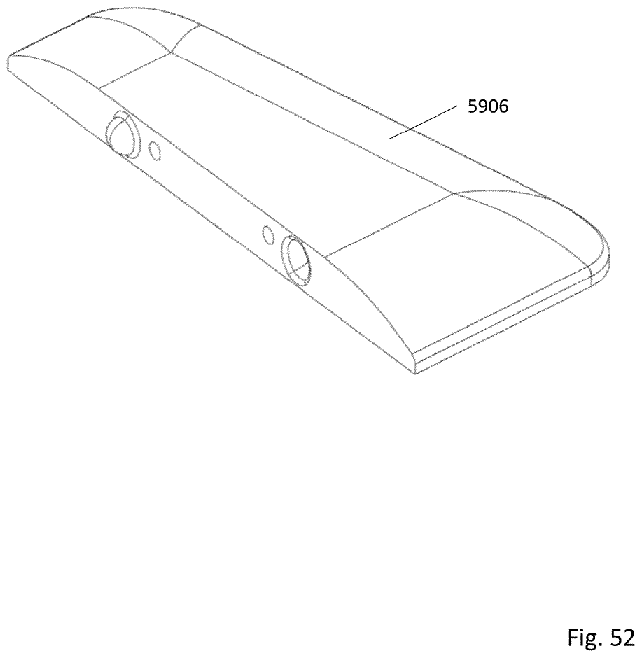

FIG. 50 is a top view of a second base end 5906 of the base assembly 5900 of the vehicle station in accordance with an illustrative embodiment. FIG. 51 is a bottom view of the second base end 5906 of the base assembly 5900 in accordance with an illustrative embodiment. It is noted that the sides of the second base end 5906 can be the same as those shown in FIG. 48, the front can be the same as the base assembly shown in FIG. 8, and the rear can be the same as the base assembly shown in FIG. 10. FIG. 52 is a perspective view of the second base end 5905 of the base assembly 5900 in accordance with an illustrative embodiment.

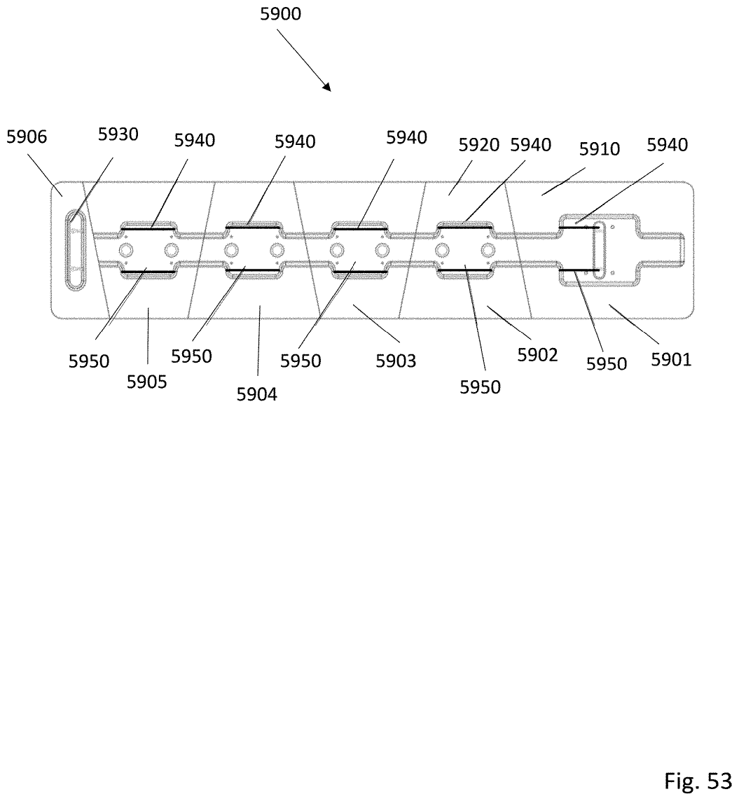

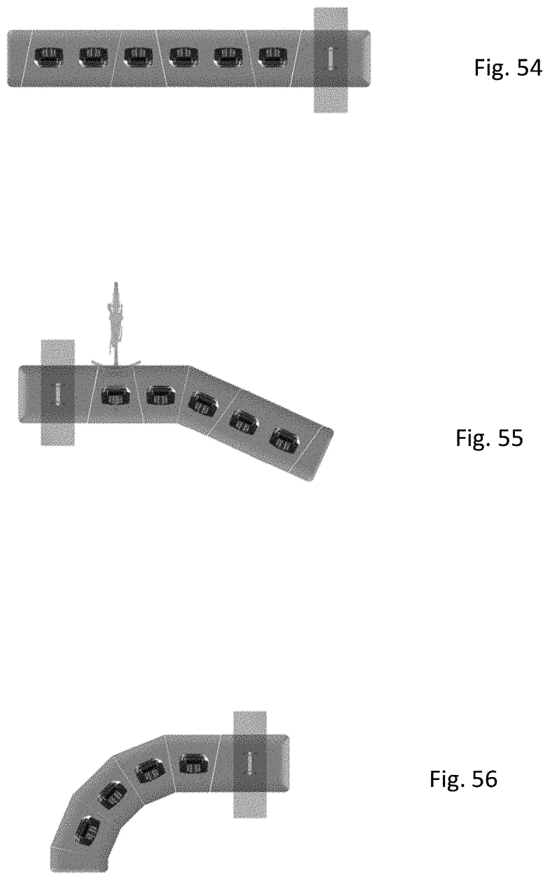

FIG. 53 is a bottom view of an assembled base assembly 5900 of a bicycle station in accordance with an illustrative embodiment. As discussed, the kiosk 64 and dock 1000 can be attached to the base 5900. The base 5900 can include multiple sections as discussed above. In one embodiment, the base sections can include a rotomolded back section that can be easily replaced. Example of base sections are 5901, 5902, 5903, 5904, 5905 and 5906. The base sections can be shaped like trapezoids in one embodiment. This way, the base sections can be linked together in various shapes. For example, FIG. 54 is a top view of a bicycle station in a first configuration in accordance with an illustrative embodiment. The first configuration is a straight configuration. FIG. 55 is a top view of a bicycle station in a second configuration in accordance with an illustrative embodiment, where the second configuration is a hockey stick layout. FIG. 56 is a top view of a bicycle station in a third configuration in accordance with an illustrative embodiment. The third configuration is curved. In alternative embodiments, any other configurations may be used such as circular, semi-circular, square, etc. In other alternative embodiments, the base sections can have different shapes such as square, rectangular, triangular, etc. that interlock together to form various shapes.

In an illustrative embodiment, the base sections 5901, 5902, 5903, 5904, 5905 and 5906 can include a tab and a slot on each connecting side. The base end sections 5901 and 5906 may include a single connecting side, in some embodiments (i.e., the other side can be finished for aesthetic purposes). The tab can be a hemisphere 3010 and the slot can be a hemispherical depression 3040. Alternatively, different mating shapes, connectors, and/or fasteners can be used. The base sections 5902, 5903, 5904, and 5905 can include holes 3020 and 3030 that extend the length of the section and into corresponding holes in the end base sections 5901 and 5906. A first cable 5940 can be run through holes 3020. A second cable 5950 can be run through holes 3030. The cables can be attached to an end base section and tightened at the other end base section. For example, in one implementation, the kiosk can include a tightening mechanism. In this way, the base sections are secured to another by cables which are inaccessible to the user. In an illustrative embodiment, the base sections can be fastened to the ground with anchors (e.g., bolts) and/or ballasted with supplemental weights.

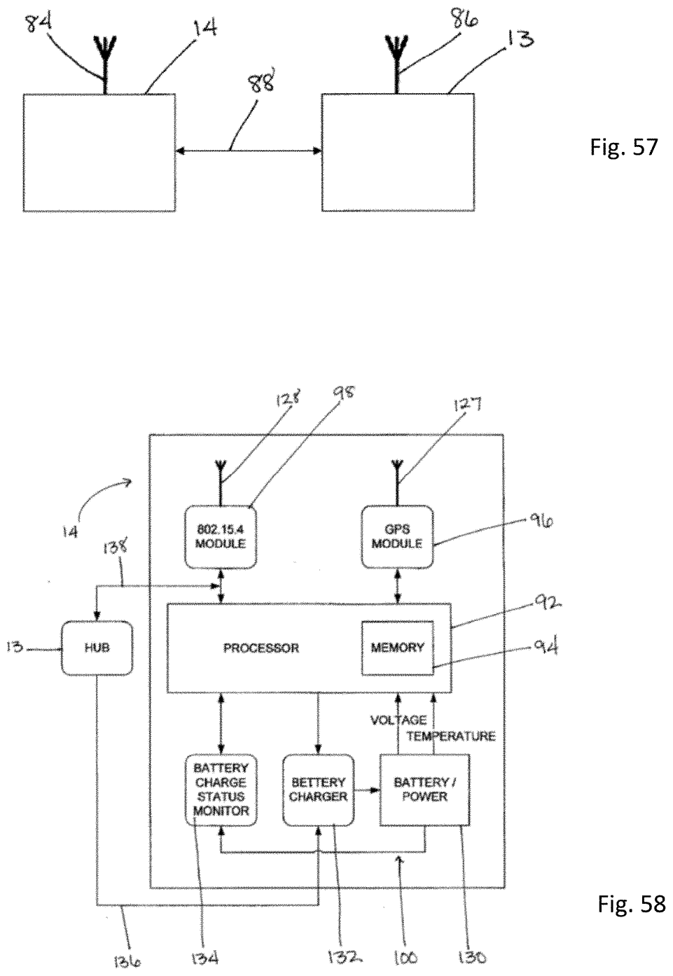

FIG. 57 is a block diagram of a bicycle computer and a power generating hub assembly in accordance with an illustrative embodiment. More specifically, FIG. 57 depicts a schematic representation of the bicycle computer 14 in operable communication the power generating hub 13. In particular, as illustrated, the bicycle computer 14 includes a wireless communication element 84, which is shown as an antenna. In an illustrative construction, the bicycle communication element 84 is in the form of an RF transmitter/receiver. The bicycle communication element 84 may be configured for unidirectional or bidirectional wireless communication with the hub assembly 13. The hub assembly 13 also includes a communication element 86, again shown as an antenna, which again may be in the form of a RF transmitter/receiver. In the alternative or in addition to, the bicycle computer 14 and the hub assembly 13 may be configured to communicate over one or more wired connections 88. As discussed herein, the power generating hub 13 can be used to power the bicycle computer 14, a battery, and/or any other accessories of the bicycle.

FIG. 58 is a block diagram of a bicycle computer 14 in accordance with an illustrative embodiment. The bicycle computer 14 includes a processor 92 having a memory element 94, either internal or external that is in operable communication with a GPS unit 96, communication module 98, and power module 100. In an alternative construction of the bicycle computer 14, GPS and RF chipsets may be provided on a single printed circuit board. The memory element 94 may be non-volatile memory such that in the case of total battery loss, the stored route data at the bicycle computer 14 will be preserved.

In an alternative construction of the bicycle computer 14, the bicycle 10 may include an alternative arrangement for obtaining the bicycle's relative position and for tracking the route traveled thereby. In particular, the bicycle 10 may be outfitted with a gyroscope, electronic compass, or similar element (not shown) that may be used to calculate the bicycle position by estimating the direction and distance traveled, e.g., dead reckoning. The gyroscope, compass, or other element may be in electronic communication with the bicycle computer 14 via a power generating hub or similar arrangement. The data obtained from the gyroscope, compass, or other element may be utilized exclusively or in combination with the GPS module 96 so that when the bicycle 10 is operating in areas with poor or no satellite reception, the bicycle computer 14 may still track the route. In some embodiments, the GPS can be implemented via cellular communication and/or alternative communication methods to offload the acquired data.

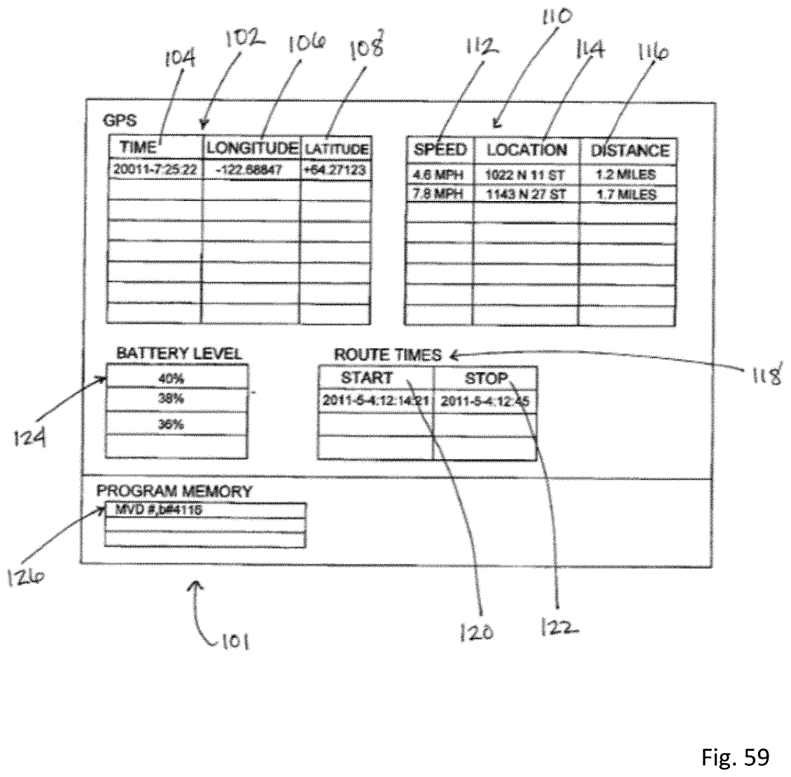

FIG. 59 is a block diagram of a memory of the bicycle tracking computer and a number of parameters stored therein in accordance with an illustrative embodiment. In an illustrative embodiment, the bicycle computer 14 is configured to log trip data 101 such as GPS position data 102 by way of the GPS module 96 or GPS chipset at predetermined intervals. In one implementation, the GPS position is logged every 30 seconds. Alternatively, different time periods may be used, such as 10 seconds, 60 seconds, etc. In another implementation, the GPS position may be dynamically logged relative to a speed of travel of the bicycle 10. With respect to the position data 102, each logged data point may include a timestamp 104, longitude reading 106, and latitude reading 108. Moreover, using the GPS position data 102, the bicycle computer 14 may be configured to derive usage data 110 including speed 112, location 114, distance traveled 116, and route time data 118 including start times 120 and stop times 122. This may also be done subsequently and remotely from the bicycle computer 14. The bicycle computer 14 may additionally monitor and provide a battery level indication 124 and may provide a program memory 126 for performing software updates to the bicycle computer 14 via a wired or wireless interface. Understandably, the parameters listed here such as position data 102, usage data 110, battery level 124, route times 118, and program memory 126 are merely illustrative and any number of other parameters as may be desired can be logged as trip data 101.

Now referring back to FIG. 58, the communication module 98 may be an RF module such as an 802.1 5.4 module or similar such module known in the art and include an RF antenna 128 for wirelessly communicating with the kiosk 64 as described herein. The hub may be operably coupled with the communication module 98 by a wired connection 138 for communication therebetween.

The power module 100 of the bicycle computer 14 includes a battery 130, battery charger 132, and battery charge status monitor 134. The battery charge status monitor 134 is configured to monitor the battery level to provide the battery level indication 124. In an illustrative embodiment, the power module 100 is configured to self-charge the bicycle computer 14 and more particularly to self-charge the GPS module 96. In particular, when the battery charge status monitor 134 indicates that the battery level indication 124 is below a predetermined threshold, the bicycle computer 14 is configured to automatically charge the battery 130 via the battery charger 132. In particular, the battery charger 132 is operably coupled with the kiosk 64 via a wired connection 136 and the kiosk includes one or more power sources for providing power to the charger 132 for charging the battery 130. In this manner, the bicycle computer 14 is ensured of having sufficient power to continually log GPS data.

The charge status monitor 134, in addition to monitoring the power consumption of the battery 130 of the bicycle computer 14, may additionally monitor the power available from the power generating hub assembly 13, which may vary upon the bicycle speed. As the bicycle moves faster, more power will become available from the power generating hub assembly 13. This can be used to charge the battery at a faster rate and also turn on additional features at the bicycle computer 12. For example, the additional features may include fast bicycle position tracking, a heater for battery warming, fast charging of the battery, activation of accessories (e.g., lights), etc. If the battery 130 is depleted, then the bicycle computer 14 may turn off features to save battery life. For example, the bicycle computer 14 may turn off GPS position tracking and radio communications. The battery charging may be disabled if the battery temperature is outside the recommended battery charging temperature range. When the battery 130 is too cold, a battery heater may be enabled to warm the battery 130 above its minimum threshold.

The bicycle computer 14 may additionally include an accelerometer, gyroscope, three-axis compass, or similar arrangement that can be used to detect a collision or fall, which may then be used by service personnel of the bicycle tracking system 12 to respond to the bicycle 10 and assist the user. For example, upon detecting a possible fall, the bicycle computer 14 can transmit an alert to the central server such that service personnel can assess the situation and determine whether and how to respond. Detection of a possible fall can also trigger a maintenance check for the bicycle involved.

Turning now to FIG. 60, a detailed schematic illustration of the bicycle rental kiosk 64 of the system is provided. The bicycle rental kiosk 64 includes a kiosk radio hub 140 that is configured to wirelessly communicate with the bicycle computers 14 via the corresponding communication modules 98 thereof. In this manner, the kiosk radio hub 140 is configured to receive trip data of the bicycles 10 from the bicycle computers 14. Once the kiosk radio hub 140 receives trip data from the bicycle computer 14, the kiosk radio hub transmits the trip data to the enterprise server 90 via a network connectivity module 142. The network connectivity module 142 can be a router, modem, ethernet, etc. The network connectivity module 142 is in direct or indirect communication with the kiosk radio hub 140. The bicycle rental kiosk 64 further includes the kiosk computer 66 that is configured to control the checking in and out of the bicycles 10 from the parking rack 68. The kiosk computer 66 is configured to transmit a signal via the network connectivity module 142 whenever a bicycle 10 is removed or returned to a parking rack 68 that is part of the system. As previously discussed, the kiosk computer 66 is configured to identify the particular bicycle 10 that has been checked in or out by way of the interaction between the identification element 15 of the bicycle and the identification reader 69.

Communication between the communication module 98 of a bicycle computer 14 and the kiosk radio hub 140 may be carried out over any number of known transmission protocols including Long Range (LoRa) low power communication, Helium LongFi (which combines the LoRaWAN wireless protocol with the Helium blockchain), ZigBee (2.4 GHz, IEEE 802.15.4 wireless communication), Bluetooth (IEEE 802.15.1), general packet radio source (GPRS), such as, 2G, 3G, or 4G, Bluetooth Low Power (BLP or BLE), mesh network (IEEE 802.15.5), wireless Ethernet, and/or any other such industry standard or custom protocol configured for wireless communication.

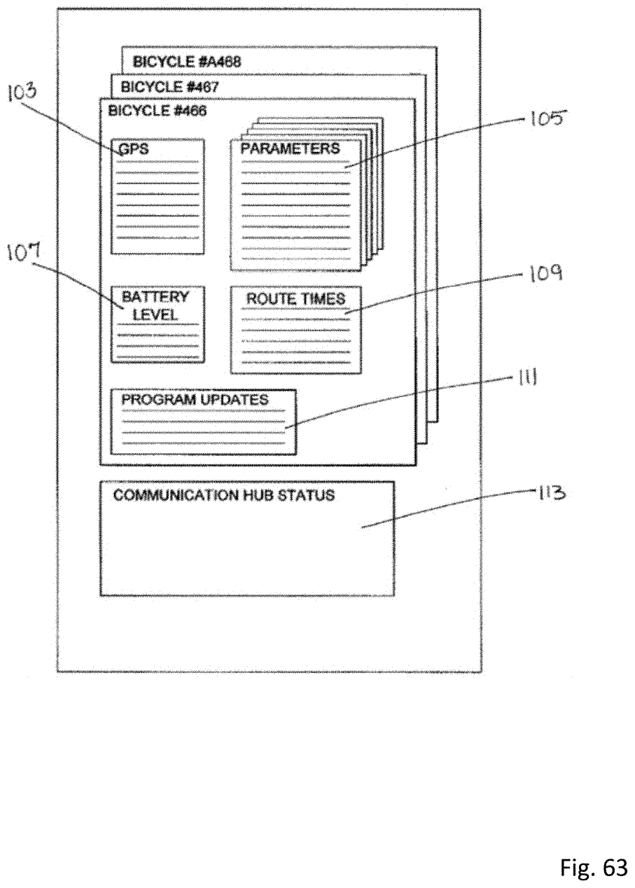

Referring momentarily to FIGS. 59 and 63, the kiosk computer 66 may include a memory unit 143, which may be either internal or external and may further include Ethernet and USB connections. The memory unit 143 of the kiosk computer 66 may be configured to store the trip data 101 received from the bicycle computers 14, as shown in FIGS. 59 and 63. The trip data 101 can associate each of the bicycles 10 of the system 12 with its given trip data, including GPS data 103, parameters derived from the GPS data 105, battery level 107, route times 109, program update data 111, and communication hub status information 113. In alternative embodiments, fewer or additional types of information may be included.

The kiosk computer 66 can also include a battery 145 coupled to a battery charger 147, which may be in communication with the power supply element 80, e.g., a solar panel or grid power source. In this manner, the power supply element 80 may charge the battery 145 for continued operation of the kiosk computer 66.

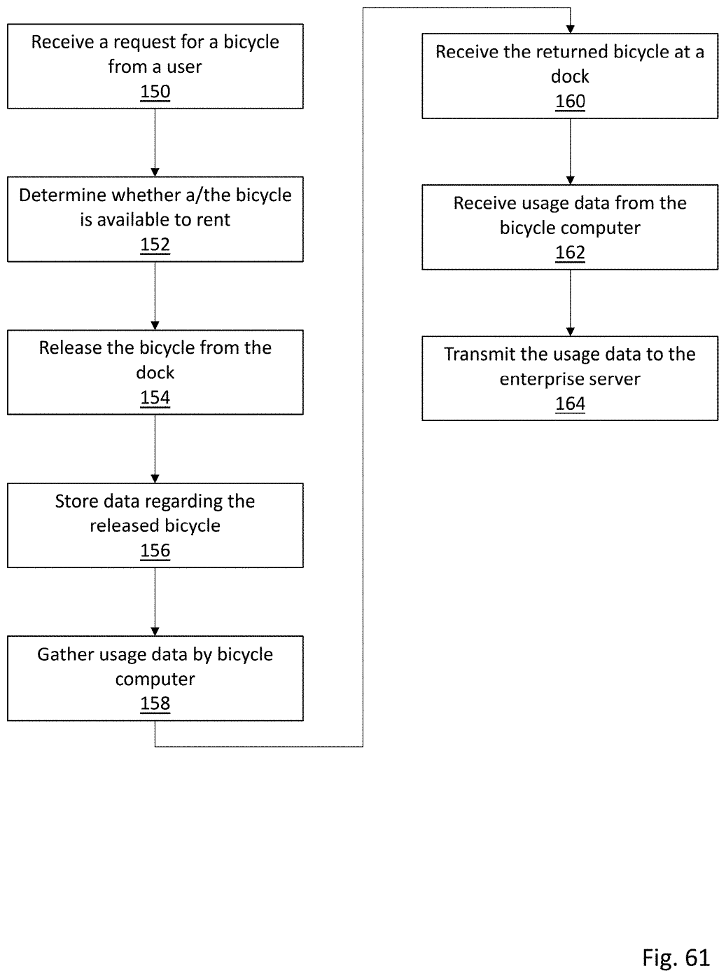

FIG. 61 is a flowchart depicting operations performed by a vehicle station system to rent and monitor bicycles in accordance with an illustrative embodiment. The order of operations in the flow chart is not meant to be limiting, and fewer, additional, and/or different operations may be performed in alternative embodiments. Also, the operations of FIG. 61 can be performed by a dock of the system and/or by a kiosk of the system (if present). In an operation 150, the system receives a request for a bicycle from a user. In some embodiments, the user can access an interface to initiate the request. The interface can be through a display incorporated into the dock or kiosk, through an application installed on a user's device (e.g., smartphone) that communicates with the dock/kiosk, through a website, etc. The request can be a general request for any available bicycle or a request for a specific bicycle at the station. The request can also include presentation of payment and/or authentication via a user authorization element of the system, which can be present on the kiosk and each individual dock. For example, when a particular user wishes to rent a bicycle 10 from one of the parking racks 68 on the system 12, he or she may do so by supplying payment in the form of a credit card or other identification such as a membership card, fob, or the like at the user authorization element. In one embodiment, biometric authentication (e.g., fingerprints, eye scan, facial recognition, etc.) can be used to authenticate the user with the system. In some embodiments, the entire request is performed through the authorization/payment procedure, and the user does not access a display or press any buttons of the system. Alternatively, the request can be implemented both through the system interface and the user authentication/payment element. In an alternative embodiment, any of the authentication, payment, and other rental operations can be performed by the user through a bicycle computer mounted to the bicycle. In such an embodiment, the bicycle computer can include any of the components/functionality of the kiosk, as described herein.

In an operation 152, the system determines whether a bicycle is available for rental. The system can determine if the bicycle is available by reviewing data associated with the bicycle to ensure that the bike does not have a known mechanical issue, to ensure that the bike is properly locked into the system (and thus can be properly released) by verifying that the latches are in the correct position, by verifying that the bicycle does not require routine maintenance based on the known amount of usage, etc. If the user has requested a specific bicycle and that bicycle is unavailable, the system can indicate that one or more other bicycles at the location are available to rent if the user desires. If the system determines that no bicycles are available to rent at the location, the system may provide the user with information regarding where a bicycle is available for rental, e.g., at another vehicle station in the vicinity.

In an operation 154, the system releases the bicycle to the user. Specifically, once rental of the bicycle has been authorized at the dock or kiosk and a bicycle identified as available, the dock/kiosk releases the bicycle to the user by activating the locking arrangement to unlock the bicycle from the dock. If the authentication occurs at a kiosk, the kiosk can electronically communicate with one of the docks of the parking rack to unlock its bicycle. If the authentication occurs at the dock, the dock can open its own lock, or alternatively the lock of another dock if the bicycle at the dock where authentication occurred is not available. Similarly, if the authentication occurs via a bicycle computer, the bicycle computer can be used to communicate with and unlock the dock at which the bicycle is stored.

In an operation 156, the system stores data regarding the released bicycle. The data can include an identification of the user that checked out the bike, the location from which the bicycle was rented, an identifier of the bicycle, etc. For example once the bicycle is unlocked from the dock of the parking rack, the identification reader at the dock can transmit a signal to the identification element on the bicycle (e.g., RFID tag), and the identification element provides a signal back to the identification reader that identifies the particular bicycle that has been rented. This information can be stored at the dock and/or transmitted to the kiosk computer. The information can also subsequently be transmitted to the enterprise server so that the enterprise server is notified of the removal of the bicycle for riding by the user. In this manner, the system is able to correlate a given user with the particular bicycle that he or she has rented, and a record of the renting of that bicycle 10 may be transmitted to the user's profile.

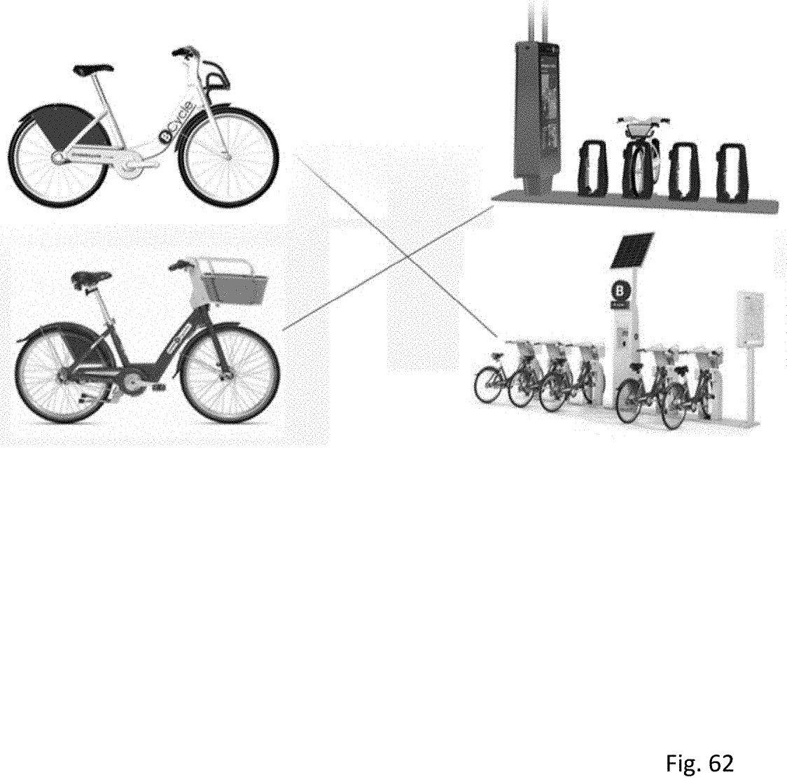

The user is then able to ride the bicycle for a desired period of time. In some embodiments, there may be a time limit at which the bicycle needs to be returned by the user. In an operation 158, the bicycle gathers usage data during the rental period. For example, during the course of a ride, the computer and/or GPS module of the bicycle can log and record the user's trip data, as previously described herein. In an operation 160, the system receives the returned bicycle at a dock. In an illustrative embodiment, the user returns the bicycle by pushing the front tire of the bicycle into a vacant dock such that the striker loops mounted to the front fork and wheel hub engage a latch on the dock. Upon engagement of the latch, the latch transitions from an open position to a closed position, thus locking the bicycle to the dock until such time when it is released to another user. Alternatively, a different type of locking arrangement may be used. The dock to which the bicycle is returned can be the same dock from which it was rented, a different dock at the same location from which the bicycle was rented, or a dock at a different vehicle station system (i.e., at another location within a city/region). FIG. 62 is a diagram of system interchangeability in accordance with an illustrative embodiment. As shown, the bicycles do not have to be returned to the same location from which they are rented. In implementations where the system includes different versions of bicycle docks (e.g., v1, v2, v3, etc.), the bicycles can also be returned to a different dock type than the one from which the bicycle was originally rented.

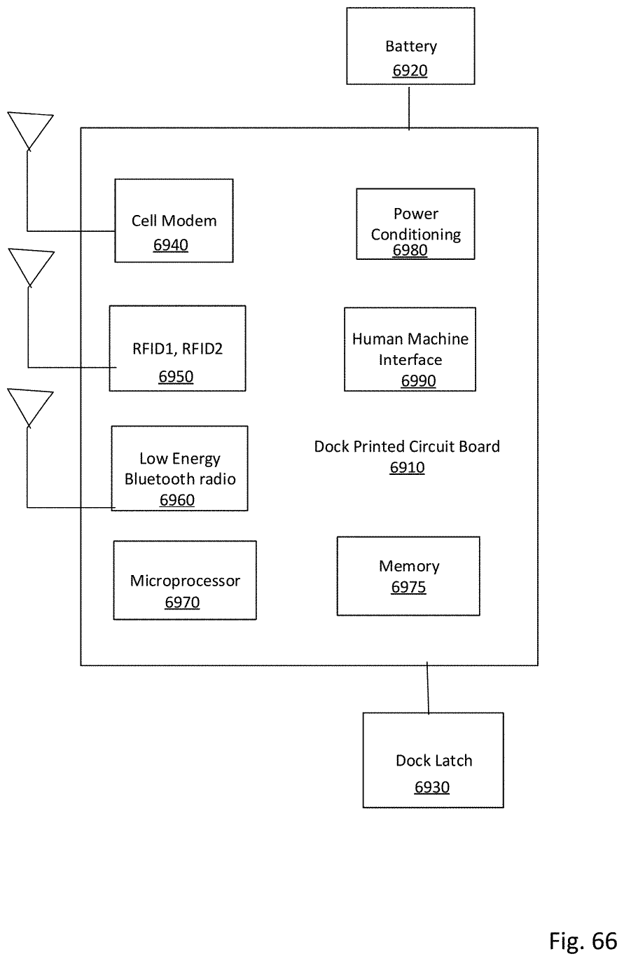

In an operation 162, the system receives the usage data from the bicycle computer. The usage data can be received at the dock to which the bicycle is returned and/or the kiosk at the location where the bicycle is returned. For example, referring to FIG. 63, when the bicycle is returned, the bicycle computer can be configured to wirelessly transmit the collected trip data 101 via its communication module to the kiosk radio hub and/or to a communication element of the dock (e.g., elements 6940, 6950, 6960 of FIG. 66). In an illustrative embodiment, the communication module of the bicycle computer is configured to be operative to communicate the trip data 101 in a range of between approximately 0-60+ meters line of sight from one another using an antenna of the kiosk radio hub or dock. Alternatively, other ranges may be used depending on the configuration. The antenna at the kiosk/dock may be a dipole antenna in some embodiments.

In an illustrative embodiment, the rate of data exchange may be configured so that the trip data 101 transmitted by the communication module to the kiosk radio hub 140 and/or dock may be done in less than four seconds for an eight-hour ride. Moreover, the kiosk radio hub 140 and/or dock may be configured for frequency hopping to avoid interference. More particularly, if the kiosk radio hub 140 or dock experiences interference, they can be configured to switch channels and then resume data acquisition without loss of trip data 101. In one embodiment, the kiosk radio hub 140 or dock may be able to pause or cancel a particular data acquisition if required, for example, to transmit a higher priority message to another bicycle computer.

In another illustrative embodiment, the system also identifies the bicycle being returned via the identification element and identification reader, as described herein. The usage data can thus be associated with the bicycle. Once the bicycle is identified, the identification reader relays the information to the kiosk computer or dock computer, which can then store a record indicating return of the bicycle. Accordingly, the system is able to determine which user has returned his or her bicycle by matching the bicycle identification with the user who rented that bicycle.

In an operation 164, the system transmits the usage data of the bicycle to the enterprise server. For example, in some embodiments, the kiosk radio hub can transmit the trip data 101, user identification, bicycle identification, etc. to the enterprise server via the network connectivity module as previously discussed. Alternatively, in some embodiments, the dock can transmit this data directly to the enterprise server, bypassing the kiosk. Once the trip data 101 is received by the enterprise server, the trip data 101 can be associated with the specific user's individual profile. The trip data 101 can then be aggregated with his or her previous ride statistics. Further, the trip data 101 can then be provided to the user in the form of a ride map or other format.

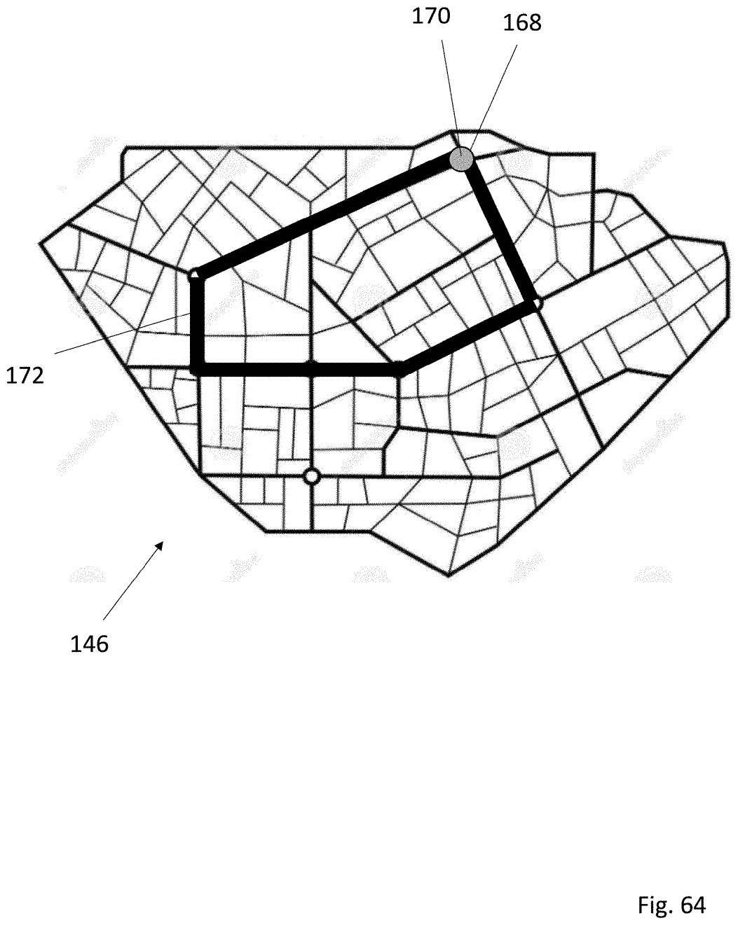

FIG. 64 depicts a ride map 146 in accordance with an illustrative embodiment. The ride map 146 may be shown as a satellite image or rendering of the area immediately surrounding the route taken by the user. The ride map 146 may identify a starting location 168 and ending location 170, which may be the same location if the user begins his or her ride at the same vehicle station as the one to which it the bicycle 10 is returned. The ride map 146 may further include a graphical representation of the route take by the user shown as route identification 172. The ride map 146 may include additional features as may be desired and may be viewed in a number of alternative formats.

The ride map 146 can be transmitted to the user via e-mail to a predefined user e-mail address so that the user may subsequently review or share the ride map 146. Alternatively, the ride map 146 can be presented through an app, a website, a text message, etc. Further, the ride map 146 may be automatically transmitted to a social networking account associated with the given user, for example, Facebook® or Twitter®. Thus, the user's ride map 146 may be automatically shared with his or her friends via the user's various social networking accounts. Understandably, the system 12 may be configured so that the user may manually upload the ride map 146 to his or her social networking accounts.

One of the advantages of the system 12 is in providing the trip data 101 to the operators of the system 12, which enables city planners and other interested parties able to determine how to better implement the bicycle sharing/rental system. For instance, the information may be used to judge where additional bicycle lanes may be desired based on determining where the bicycles are ridden with greatest frequency. In addition, it may assist operators in determining where to best locate the vehicle stations and determine how existing bicycle paths are being utilized and whether changes are desired to improve usage.

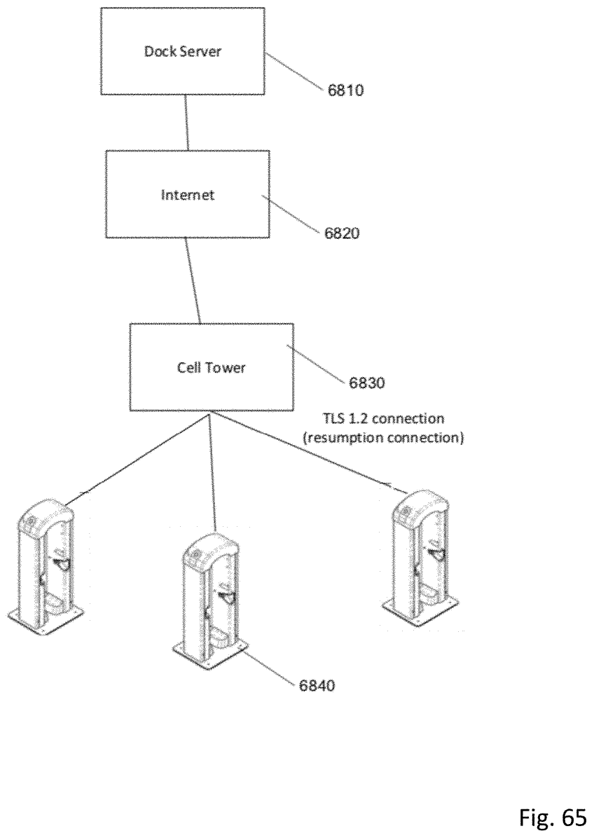

FIG. 65 is a block diagram depicting dock communication in accordance with an illustrative embodiment. As shown, each bicycle dock 6840 can individually communicate with a server 6810 (e.g. enterprise server 90). The server 6810 is communicatively coupled to each bicycle dock 6840 through Internet 6820 and/or a cell tower 6830. In one embodiment the communication coupling supports resumption, such as, for example, the TLS 1.2 protocol. Using such a resumption protocol, when a connection is made from the server 6810 to a bicycle dock 6840, the connection is persistent. After the initial connection is made, a connection does not need to be reestablished each time the server 6810 communicates with the bicycle dock 6840. This reduces communication latency by about a factor of 7-10.

In some embodiments, communication between the bicycle dock 6840 and the server 6810 is initially established through a back end of the system using handshakes to exchange tokens, etc. as known in the art. In traditional systems, such an authentication expires upon expiration of the token(s) used to authenticate, and the tokens can expire after passing of a predetermined amount of time without communication. Upon expiration, the whole authentication process has to be performed again, consuming additional power. Using the resumption protocol, the communication connection can be maintained for extended periods (or even indefinitely) without further handshakes. In some embodiments, the system (or an operator thereof) can control the amount of time before expiration of a received authentication token. This expiration time can be based on configuration of the system, and can be set such that the token will not expire under normal operation. For example, if the system is configured such that communication between the system and the server is to occur every 3 hours, the token expiration can be set to 3.5 or 4 hours to ensure that the communication connection does not expire during normal operation. The use of resumption allows the communication connection to be maintained even when the dock is powered down. In the event that the connection is lost for some reason, the system is configured to automatically reauthenticate with the remote server.

In addition, the connection from the server 6810 to a bicycle dock 6840 can use message queuing telemetry transport (MQTT). MQTT is a machine-to-machine (M2M)/“Internet of Things” connectivity protocol designed for a small code footprint and/or limited network bandwidth. Thus the communication link is asynchronous in that a constant connection is not required for the connection to persist. Advantageously, latency is lowered, less data is used, and less power is used. Additionally, the foregoing reduces the costs of the operation for communication between the server 6810 and the bicycle dock 6840. Alternatively, a different connectivity protocol may be used.

FIG. 66 depicts a computing system of a bicycle dock 6840 in accordance with an illustrative embodiment. The computing system can be incorporated into any of the docks described herein, such as dock 1000. A control board 6910 of the bicycle dock 6840 is shown. The control board 6910 can include a microprocessor 6970, a memory 6975, a cell modem 6940, a RFID radio 6950 (which operates at 2 different frequencies), a low energy Bluetooth radio 6960, a power conditioning unit 6980, and a human machine interface 6990. Each of the microprocessor 6970, the memory 6975, the cell modem 6940, the RFID radio 6950, the low energy Bluetooth radio 6960, the power conditioning unit 6980, and the human machine interface 6990 can be turned on and off individually. The control board 6910 can be connected to a battery 6920 and a dock latch 6930 which is controlled by the control board 6910. The battery 6920 can be a single battery, or a plurality of batteries, depending on the implementation.

The human machine interface 6990 can include a capacitive touch screen, LED screen, etc. that allows the user to interact directly with the dock. The human machine interface 6990 can also include any of the user authentication elements described herein. In some embodiments, each dock can be equipped with such interfaces, thereby eliminating the need for a kiosk. For example, any of operations described herein with respect to the kiosk can instead be performed by each individual dock of the system. In this way, multiple users can checkout bicycles at the same time. Additionally, the docks can be resilient such that if one dock becomes inoperable, the other docks can still be fully functional.

In an illustrative embodiment, the dock latch 6930 includes one or more state sensors that detect whether the dock latch 6930 is in an open or closed position (i.e., latch status), and whether the locking mechanism behind the cam latches is engaged or disengaged. This latch status information can be communicated to the kiosk (if used) and the remote server. In some embodiments, a single dock latch is used to secure a front tire of the bicycle in the dock. Alternatively, each dock can include 2 (or more) latches and 2 (or more) corresponding sensors. In one implementation, striker loops can be mounted to each side of the bicycle front tire hub. The striker loops can be square, rectangular, circular, etc. in shape, and can contact an open latch. Specifically, upon placement of the bicycle in the dock during a return, the striker loops contact the dock latch 6930 (or latches) and causes it to transition from an open or unlocked position to a closed or locked position. In an illustrative embodiment, the dock latch 6930 is a magnetically actuated solenoid that can be de-energized in between state changes (i.e., the latch does not require constant high power to maintain its current (open or closed) position). In the de-energized state, the dock latch can draw low or no power, depending on the implementation. Upon a state change (opening or closing) of the latch, the dock latch 6930 is energized to perform the state change, and then de-energized again until a subsequent state change.

The power conditioning unit 6980 of the dock can be configured to perform power conversion and to selectively deliver the appropriate amount of voltage to the various components of the dock on an as-needed basis to conserve power. In one embodiment, the power conditioning 6980 can generate 0 Volts (V), 3.3 Volts, 3.5 V, and 12V signals to power the various components of the dock. Alternatively, other voltages may be used, depending on the components. In the case of 0 V, no power is provided such that the component(s) receiving 0 V are powered down until needed. As an example, the 3.3 V signal is used to power the microprocessor 6970, and the 3.3 V signal is only generated at times when the microprocessor 6970 is active. The 3.3V signal can also be used by the cell modem. Similarly, the 3.5 V and 12 V signals can be selectively generated to power specific components of the dock, only when those components are in need of the power to perform a specific operation.

The control board 6910 can have multiple modes in which various sections of the control board 6910 are in different power states, for example, on, off, or sleeping to conserve power. The control board 6910 has a program in the memory 6975 with various modes. In a first sleep mode, a majority of the components of the control board 6910 are sleeping (this typically occurs about 60-70% of the time). For example, the cell modem 6940, the RFID radio 6950, and the lower energy Bluetooth® radio 6960 may be inactive. Additional components can also be made inactive. For example, the microprocessor 6970 may be put to sleep, with the exception of a timer to control periodic wake ups. While in the sleep mode, the microprocessor 6970 can also poll to see if an interrupt such as a button of the dock is pushed, a bike is placed in the dock, or some other input is received. If such an input is detected, the control board 6910 transitions to one of the awake modes. After completion of a transaction (e.g., a checkout) or after a duration of time has passed without any activity, the control board 6910 transitions back into the sleep mode. The duration of time can be 45 seconds in one embodiment.

In a second heartbeat mode, the microprocessor 6970 wakes-up after an amount of time, then wakes-up the cell modem 6940, and communicates with the server 6810 (i.e., communicates via the Internet connection established via TLS 1.2 and MQTT). The microprocessor 6970 reports all information available such as Dock ID, Bike Present?, Bike ID, Bike Battery Level, Dock Battery Level, Latch State, etc. The microprocessor 6970 can then return to low power mode. In a third check in mode, the microprocessor 6970 wakes up after an interrupt (button push, etc.) and then executes the foregoing heartbeat mode operations. The microprocessor 6970 also communicates check in information and operations such as Bike ID and opening and closing of the dock latch 6930, before returning to low power mode.

In a fourth check out mode, the microprocessor 6970 wakes up after an interrupt (button push, etc.) and executes the foregoing heartbeat mode operations. Then the microprocessor 6970 communicates check out information and operations such as Bike ID and opening and closing of the dock latch 6930. As discussed, the user can use an RFID card to check out a bike at a dock or use a mobile program that either communicates via the cell network or the server 6810 to activate check out, or via a Bluetooth connection between the cell phone and the Bluetooth radio 6960. In a fifth mode, the firmware is updated on the memory 6975. In a sixth mode, the dock sends its logs back to the server 6810. In a seventh mode, the dock shuts itself down. In alternative embodiments, fewer or additional modes may be used.

Other implementations of the system can include other features and functionality. For example, in one embodiment, the system kiosk may be used in conjunction with a BBT receiver and/or the most current version of the docks to act as part of an overall system configuration. The kiosk may also be used as part of a legacy station refurbishing system to upgrade legacy stations with current software, etc. In another embodiment, in-dock battery charging can be implemented via a direct wired power transfer and/or via wireless inductive power transfer. In another embodiment, controller area network flexible data rate (CAN FD) networking can be used for any of the network communications described herein.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A vehicle station system, comprising:
a dock, wherein the dock comprises:
a latch configured to secure a bicycle to the dock and release the bicycle from the dock; and
a computing system that includes:
a processor;
an interface operatively coupled to the processor and configured to receive authentication information from a user;
wherein the processor is configured to authenticate the user based on the authentication information, and, responsive to authentication of the user, cause the latch to transition from a locked configuration to an open configuration such that the user can remove the bicycle from the dock; and
a transceiver operatively coupled to the processor and configured to maintain a communication connection between the dock and a remote server, wherein the transceiver is also configured to transmit a user identification corresponding to the user and a bicycle identification corresponding to the bicycle to the remote server.

2. The vehicle station system of claim 1, wherein the latch is de-energized in between state changes from the locked configuration to the open configuration and the open configuration to the locked configuration.

3. The vehicle station system of claim 1, wherein the interface includes one or more card readers to receive one or more of the authentication information and payment information.

4. The vehicle station system of claim 1, wherein the communication connection comprises a persistent communication connection implemented via a resumption protocol.

5. The vehicle station system of claim 1, wherein the transceiver comprises a plurality of transceivers including a cellular transceiver, a radio frequency identification (RFID) transceiver, and a low energy transmission transceiver.

6. The vehicle station system of claim 1, wherein the dock further includes a power conditioning unit configured to generate a plurality of different power signals and to selectively provide power to components of the dock with the plurality of different power signals and to remove the power when the components are not in use.

7. The vehicle station system of claim 1, further comprising the bicycle, wherein the bicycle includes a bicycle computer that includes a global positioning system (GPS) unit and a memory configured to store GPS information in the form of ride data.

8. The vehicle station system of claim 7, wherein the ride data is based on usage of the bicycle by the user and includes speed data, location data, distance data, and timing data corresponding to the usage of the bicycle.

9. The vehicle station system of claim 7, wherein the bicycle computer is configured to provide the ride data to a return dock at which the bicycle is returned by the user.

10. The vehicle station system of claim 9, wherein the return dock comprises the dock or another dock at the same vehicle station as the dock.

11. The vehicle station system of claim 9, wherein the return dock comprises another dock at a different vehicle station from where the bicycle was checked out.

12. The vehicle station system of claim 1, further comprising a base assembly to which the dock is mounted, wherein the base assembly comprises a first base end, a plurality of base sections, and a second base end that are able to mount to one another in a plurality of configurations to form the base assembly

13. The vehicle station system of claim 12, wherein the plurality of base sections include a first through hole and a second through hole, wherein a first cable runs through the first through hole and a second cable runs through the second through hole to secure the base sections to one another.

14. The vehicle station system of claim 13, wherein the first cable and the second cable each mount to the first base end and the second base end.

15. A vehicle station system, comprising:
a base assembly;
a dock mounted to the base assembly, wherein the dock comprises a latch configured to secure a bicycle to the dock and release the bicycle from the dock; and
a kiosk mounted to the base assembly, wherein the kiosk includes a computing system comprising:
a processor;
an interface operatively coupled to the processor and configured to receive one or more of authentication information and payment information from a user;
wherein the processor is configured to authenticate the user based on the authentication information, and, responsive to authentication of the user, cause the latch to transition from a locked configuration to an open configuration such that the user can remove the bicycle from the dock; and
a transceiver operatively coupled to the processor and configured to transmit a user identification corresponding to the user and a bicycle identification corresponding to the bicycle to a remote server.

16. The vehicle station system of claim 15, wherein the interface includes a first display and one or more readers configured to read a card or fob.

17. The vehicle station system of claim 15, wherein the transceiver is configured to receive ride data from a bicycle computer of the bicycle upon return of the bicycle, wherein the ride data is based on usage of the bicycle by the user and includes speed data, location data, distance data, and timing data corresponding to the usage of the bicycle.

18. The vehicle station system of claim 17, wherein the transceiver is configured to transmit the ride data to the remote server, and further comprising the remote server, wherein the remote server is configured to update a user profile of the user with the ride data.

19. The vehicle station system of claim 15, further comprising a battery configured to power components of the kiosk and a solar panel configured to charge the battery.

20. The vehicle station system of claim 19, wherein the solar panel is mounted to a first pole and a second pole that automatically adjust so that the solar panel tracks the sun.
